(19) United States
(12) Patent Application Publication
(10) Pub. No.: US 2013/0322897 A1
(43) Pub. Date: Dec. 5, 2013

(54) IMAGE HEATING APPARATUS

(71) Applicant: Canon Kabushiki Kaisha, Tokyo (JP)

(72) Inventors: Toshihisa Yago, Toride-shi (JP); Toshinori Nakayama, Kashiwa-shi (JP); Taichi Takemura, Abiko-shi (JP); Kota Arimoto, Kashiwa-shi (JP); Ryo Suzuki, Kashiwa-shi (JP); Kouichi Kakubari, Toride-shi (JP); Kazuhiro Hasegawa, Abiko-shi (JP)

(21) Appl. No.: 13/905,596

(22) Filed: May 30, 2013

(30) Foreign Application Priority Data
Jun. 5, 2012 (JP) 2012-127964

(51) Int. Cl. G03G 15/20; G03G 15/00

(52) U.S. Cl. CPC G03G 15/2078; G03G 15/80; G03G 15/205
USPC 399/33; 399/45; 399/67

(57) ABSTRACT

An image heating apparatus includes: (i) an endless belt; (ii) a driving member; (iii) a heater including: (iii-i) a substrate; (iii-ii) a resistor; (iii-iii) a first electroconductive portion electrically connected to the resistor in a widthwise end side; and (iii-iv) a second electroconductive portion electrically connected to the resistor in another widthwise end side; and (iv) a selector for selecting one of first and second electric energy supply paths. The first electric energy supply path is electrically connected to a region of the first electroconductive portion at a longitudinal central portion of the resistor and to a region of the second electroconductive portion in at the longitudinal central portion. The second electric energy supply path is electrically connected to a region of the first electroconductive portion at a longitudinal end portion of the resistor and to a region of the second electroconductive portion at another longitudinal end portion.

### FIELD OF THE INVENTION AND RELATED ART

The present invention relates to an image heating apparatus for heating an image on a sheet. As the image heating apparatus, it is possible to use a fixing device (apparatus) for fixing an unfixed toner image on the sheet and a gloss improving apparatus for improving glossiness of an image by heating the toner image fixed on the sheet.

Heretofore, from viewpoints of a quick start property and an energy saving property, a fixing device (image heating apparatus of a belt (film) heating type has been put into practical use. Such a fixing device includes a fixing belt (endless belt), a pressing roller (rotatable driving member) for forming a nip between itself and the fixing belt and for rotationally driving the fixing belt, and a heater (in which a heat generating resistor is provided on a substrate) provided opposed to the pressing roller via the fixing belt.

However, in the fixing device, compared with a fixing device of a fixing roller type, thermal capacity of the fixing belt is small, and therefore there is a problem such that a region of the fixing belt (heater) in a longitudinal end portion side is excessively increased in temperature when a sheet (small size) having a width narrower than a maximum width of a sheet (large size) usable in the fixing device is continuously subjected to a fixing process. This is because heat is not taken by the sheet in the region of the fixing belt (heater) in the longitudinal end portion side.

Therefore, in a fixing device disclosed in Japanese Laid-Open Patent Application (JP-A) 2007-311136, electric energy is supplied to a resistor of the heater along a sheet passing direction. Further, as a path for supplying the electric energy to electroconductive portions (functioning as electrodes) formed in widthwise sides of the resistor, two paths consisting of a first path for supplying the electric energy to the electroconductive portions so as to sandwich a longitudinal central portion of the resistor and a second path for supplying the electric energy to one of the electroconductive portions in longitudinal end sides and to another electroconductive portion in a longitudinal central side are prepared. These two electric energy supply paths are selectively used depending on a widthwise size of the sheet. Specifically, the first path is used in the case of a small-sized sheet, and the second path is used in the case of a large-sized sheet.

However, in the fixing device described in JP-A 2007-311136, in the case where the large-sized sheet is subjected to the fixing process, a temperature of the fixing belt (heater) becomes low in longitudinal end sides compared with a temperature thereof in a longitudinal central side, so that there is a possibility that improper fixing occurs due to this temperature non-uniformity.

### SUMMARY OF THE INVENTION

According to an aspect of the present invention, there is provided an image heating apparatus comprising: (i) an endless belt for heating a toner image on a sheet at a nip; (ii) a rotatable driving member for forming the nip in cooperation with the endless belt and for rotating the endless belt; (iii) a heater, provided opposed to the rotatable driving member via the endless belt, for heating the endless belt, wherein the heater comprising: (iii-i) a substrate; (iii-ii) a resistor, provided on the substrate along a longitudinal direction of the substrate, for generating heat by electric energy supply; (iii-iii) a first electroconductive portion provided on the substrate along the longitudinal direction and electrically connected to the resistor in a widthwise end side; and (iii-iv) a second electroconductive portion provided on the substrate along the longitudinal direction and electrically connected to the resistor in another widthwise end side; and (iv) a selector for selecting one of a plurality of electric energy supply paths including a first electric energy supply path for supplying electric energy to the resistor and a second electric energy supply path for supplying the electric energy to the resistor, wherein the first electric energy supply path is electrically connected to a region of the first electroconductive portion adjacent to a longitudinal central portion of the resistor and to a region of the second electroconductive portion adjacent to the longitudinal central portion of the resistor, and wherein the second electric energy supply path is electrically connected to a region of the first electroconductive portion adjacent to a longitudinal end portion of the resistor and to a region of the second electroconductive portion adjacent to another longitudinal end portion of the resistor.

According to another aspect of the present invention, there is provided an image heating apparatus comprising: (i) an endless belt for heating a toner image on a sheet at a nip; (ii) a rotatable driving member for forming the nip in cooperation with the endless belt and for rotating the endless belt; (iii) a heater, provided opposed to the rotatable driving member via the endless belt, for heating the endless belt, wherein the heater comprising: (iii-i) a substrate; (iii-ii) a resistor, provided on the substrate along a longitudinal direction of the substrate, for generating heat by electric energy supply; (iii-iii) a first electroconductive portion, provided on the substrate along the longitudinal direction, for being electrically connected to the resistor in a widthwise end side; (iii-iv) a first central electric energy supply path connected to a region of the first electroconductive portion adjacent to a longitudinal central portion of the resistor; (iii-v) a first end electric energy supply path connected to a region of the first electroconductive portion adjacent to a longitudinal end portion of the resistor; (iii-vi) a second electroconductive portion, provided on the substrate along the longitudinal direction, for being electrically connected to the resistor in another widthwise end side; (iii-vii) a second central electric energy supply path connected to a region of the second electroconductive portion adjacent to a longitudinal central portion of the resistor; (iii-viii) a second end electric energy supply path connected to a region of the second electroconductive portion adjacent to another longitudinal end portion of the resistor; and (iv) a selector for selecting one of a plurality of modes including a first mode in which the electric energy is supplied to the resistor by using the first central electric energy supply path and the second central electric energy supply path and including a second mode in which the electric energy is supplied to the resistor by using the first end electric energy supply path and the second end electric energy supply path.

According to a further aspect of the present invention, there is provided an image heating apparatus comprising: (i) an endless belt for heating a toner image on a sheet at a nip; (ii) a rotatable driving member for forming the nip in cooperation with the endless belt and for rotating the endless belt; (iii) a heater, provided opposed to the rotatable driving member via the endless belt, for heating the endless belt, wherein the heater comprising: (iii-i) a substrate; (iii-ii) a resistor, provided on the substrate along a longitudinal direction of the substrate, for generating heat by electric energy supply; (iii-iii) a first electroconductive portion, provided on the substrate along the longitudinal direction, for being electrically connected to the resistor in a widthwise end side; and (iv) an electric energy supplying device for supplying electric energy to the resistor, wherein the electric energy supplying device is connected at a plurality of positions to each of the first electroconductive portion and the second electroconductive portion.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a top plan view of a heater as a heating member in an image heating apparatus according to First Embodiment of the present invention.

FIG. 2 is a longitudinal sectional view showing a schematic structure of an electrophotographic full-color printer as an example of an image forming apparatus in which the image heating apparatus in First Embodiment.

FIG. 3 is a schematic view of a fixing device as the image heating apparatus in First Embodiment.

FIG. 4 is a block diagram of the fixing device as the image heating apparatus in First Embodiment.

FIG. 5 is an arrangement view of thermistors of the heater in First Embodiment.

FIG. 6 is a graph for illustrating a temperature control system of the fixing device as the image heating apparatus in First Embodiment.

FIG. 7 includes a top plan view for illustrating central-portion electric energy supply of the heater and a temperature distribution diagram in First Embodiment.

FIG. 8 includes a top plan view for illustrating end portion electric energy supply of the heater and a temperature distribution diagram in First Embodiment.

FIG. 9 is a flow chart of control for correcting a target temperature in the case where an end portion temperature is increased in First Embodiment.

FIG. 10 is a flow chart of temperature control in which the central portion electric energy supply and the end portion electric energy supply are switched in First Embodiment.

FIG. 11 includes schematic views showing widthwise electric energy supply heaters in Comparison Example 1 to be compared with First Embodiment.

FIG. 12 is a temperature distribution diagram of respective heaters in Comparison Example 1 and First Embodiment when electric energy is supplied to the heaters.

FIG. 13 is a temperature distribution diagram of the heater in First Embodiment and the heaters in Comparison Example 1 in the case where recording paper is actually passed in Comparison Example 2.

FIG. 14 is a temperature distribution diagram in which temperature non-uniformity occurs in the case where an operation of the central portion electric energy supply of the heater is performed for a long time in First Embodiment.

FIG. 15 includes schematic views for illustrating a heater in Second Embodiment.

FIG. 16 includes schematic views for illustrating an effect of a main body of the heater in Second Embodiment.

FIG. 17 is a schematic view of a heater in a modified example of Second Embodiment, in which electric energy supply is combined with the end portion electric energy supply in First Embodiment.

FIG. 18 includes schematic views for illustrating a heater in Third Embodiment.

FIG. 19 is a schematic view of a heater in a modified example of Third Embodiment, in which electric energy supply is combined with the end portion electric energy supply in First Embodiment.

FIG. 20 includes schematic views of heaters in modified examples of Third Embodiment.

FIG. 21 includes schematic views for illustrating a heater in Fourth Embodiment.

FIG. 22 includes schematic views for illustrating the influence of resistance on a wiring pattern and a connecting pattern which constitute a second electrode region in Fourth Embodiment.

FIG. 23 is a circuit diagram for illustrating a comparison with a temperature distribution in the case where thicknesses and widths of the wiring pattern and the connecting pattern which constitute the second electrode region are made ½ thereof.

FIG. 24 is a schematic view for illustrating a countermeasure element, during abnormal heat generation, provided in a heater in Fifth Embodiment.

### DESCRIPTION OF THE PREFERRED EMBODIMENTS

Hereinbelow, the present invention will be described specifically based on embodiments with reference to the drawings.

### First Embodiment

### (Image Forming Apparatus)

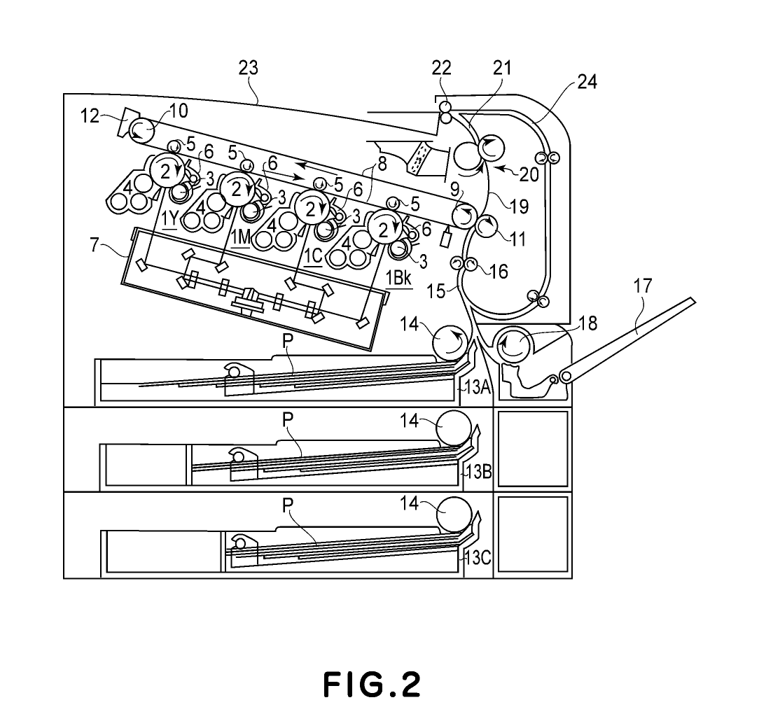

FIG. 2 is a longitudinal schematic view showing a general structure of an electrophotographic full-color printer as an example of an image forming apparatus in which a fixing device 20 as an image heating apparatus according to this embodiment of the present invention is mounted. In the image forming apparatus in this embodiment, a maximum size of a usable recording paper as a recording material is A3 size (297 mm×420 mm), and the recording paper can be conveyed in a manner such that a large edge (420 mm) of the A3-sized recording paper is parallel to a conveyance direction of the recording paper. Further, the recording paper is conveyed in accordance with a longitudinal center basis of a heat generating resistor in the fixing device 20 described later. Incidentally, in this embodiment, the A3-sized recording paper is used as a maximum-sized recording paper, but it is also possible to use, as the maximum-sized recording paper, recording paper having a size other than the A3 size.

This printer performs an image forming operation depending on image information inputted from an external host device (not shown) communicatably connected with a control circuit portion (control board: CPU) (not shown), thus being capable of forming a full-color image on the recording paper and then outputting the full-color image.

The external host device 200 is a computer, an image reader, or the like. The control circuit portion sends signals to and receives signals from the external host device, and sends signals to and receives signals from various devices for image formation to manage image forming sequence control.

An endless and flexible intermediary transfer belt 8 (hereinafter referred also simply to as a belt) is stretched between a secondary transfer opposite roller 9 and a tension roller 10 and is rotationally driven at a predetermined speed in a counterclockwise direction indicated by an arrow by rotation of the roller 9. A secondary transfer roller 11 presses the belt 8 against the secondary transfer opposite roller 9. A contact portion between the belt 8 and the secondary transfer roller 11 constitutes a secondary transfer portion.

First to fourth (four) image forming portions 1Y, 1M, 1C and 1Bk are provided in line in a lower side of the belt 8 along a belt movement direction with a predetermined interval. Each of the image forming portions is an electrophotographic process mechanism of a laser exposure type and includes a drum-type electrophotographic photosensitive member 2 (hereinafter simply referred to as a drum) as an image bearing member to be rotationally driven at a predetermined speed in a clockwise direction indicated by an arrow. Around the drum 2, a primary charger 3, a developing device 4, a transfer roller 5 as a transfer means, and a drum cleaning device 6 are provided. The transfer roller 5 is disposed inside the intermediary transfer belt 8 and presses the lower-side belt portion of the belt 8 against the drum 2. A contact portion between the drum 2 and the belt 8 constitutes a primary transfer portion. A laser exposure device 7 for each of the drums 2 of the respective image forming portions is constituted by a laser emitting means for emitting light correspondingly to a time-serial electric digital pixel signal of image information to be provided, a polygonal mirror, a reflection mirror, and the like.

The CPU as the control circuit portion causes each image forming portion to perform an image forming operation on the basis of a color-separated image signal inputted from the external host device. As a result, at the first to fourth image forming portions 1Y, 1M, 1C and 1Bk, color toner images of yellow, cyan, magenta, and black are formed, respectively, on surfaces of associated rotating drums 2. Electrophotographic image forming principle and process for forming a toner image on the drum 2 are well known in the art, thus being omitted from description.

The toner images formed on the drums 2 at the respective image forming portions are successively transferred onto an outer surface of the belt 8, in a superposition manner, which is rotationally driven in the same direction as the rotational directions of the respective drums 2 at a speed corresponding to the rotational speeds of the respective drums 2. As a result, on the surface of the belt 8, unfixed full-color toner images are synthetically formed in a superposition manner of the above-described four toner images.

With predetermined sheet feeding timing, a sheet-feeding roller 14 at a stage selected from a vertical multi-stage sheet-feeding cassettes 13A, 13B, and 13C in which various recording papers P having different widths are stacked and accommodated is driven. As a result, one sheet of the recording papers P stacked and accommodated in the sheet-feeding cassette at the selected stage is separated and fed to be conveyed to registration rollers 16 through a vertical conveying path 15. When a manual sheet feeding mode is selected, a sheet-feeding roller 18 is driven. As a result, one sheet of the recording papers placed and set on a manual sheet feeding tray (multi-purpose tray) 17 is separated and fed to be conveyed to the registration rollers 16 through the vertical conveying path 15.

The registration rollers 16 timing-convey the recording paper P so that a leading end of the recording paper (sheet) P reaches the secondary transfer portion in synchronism with timing when a leading end of the above-described full-color toner images on the rotating belt 8 reaches the secondary transfer portion. As a result, at the secondary transfer portion, the full-color toner images on the belt 8 are secondary-transferred collected onto the surface of the recording paper P. The recording paper P coming out of the secondary transfer portion is separated from the surface of the belt 8 and guided by a vertical guide 19 into the fixing device 20 as the image heating apparatus. By this fixing device 20, the above-described toner images of a plurality of colors are melted and mixed to be fixed on the surface of the recording paper as a fixed image. The recording paper coming out of the fixing device 20 is sent onto a sheet discharge tray 23 as a full-color image formed product by sheet discharge rollers 22 through a conveying path 21.

The surface of the intermediary transfer belt 8 after the separation of the recording paper at the secondary transfer portion is subjected to removal of residual deposited matter such as secondary transfer residual toner or the like by a belt cleaning device 12 to be cleaned, thus being repeatedly subjected to image formation.

In the case of a monochromatic print mode, only the fourth image forming portion 1Bk for forming the black toner image is actuated. In the case where a both-side print mode is selected, recording paper which has been subjected to printing on a first surface is sent onto the sheet discharge tray 23 by the sheet discharge rollers 22. Immediately before a trailing end of the recording paper passes through the sheet discharge rollers 22, rotation of the sheet discharge rollers 22 is reversed in direction. As a result, the recording paper is subjected to switch back to be introduced into a conveying path 24. Thus, the recording paper is conveyed again to the registration rollers 16 in a reversed state. Thereafter, similarly as in the case of the first surface printing, the recording paper is conveyed to the fixing device 20 through the secondary transfer portion, thus being sent onto the sheet discharge try 23 as a both-side image-formed product.

### (Image Heating Apparatus)

In the following description, with respect to the fixing device as the image heating apparatus and members constituting the fixing device, a longitudinal direction refers to a direction perpendicular to a recording paper conveyance direction in a plane of the recording paper, and a widthwise direction refers to a direction parallel to the recording paper conveyance direction in the plane of the recording paper. Further, a thickness direction refers to a direction perpendicular to the longitudinal direction and the widthwise direction. A length refers to a dimension in the longitudinal direction, a width refers to a dimension in the widthwise direction, and a thickness refers to a dimension in the thickness direction.

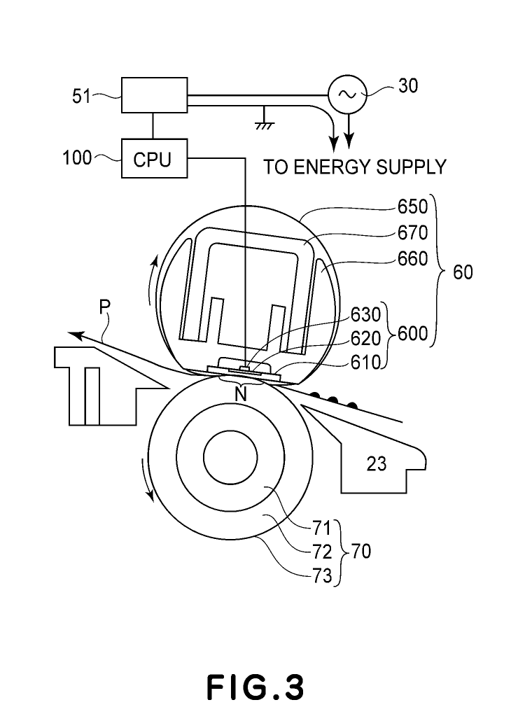

FIG. 3 is a schematic structural view of the fixing device 20 as the image heating apparatus according to this embodiment of the present invention. The fixing device 20 includes a heating member for generating heat by applying a voltage via an electrode pair to a heat generating resistor extending in the longitudinal direction, a belt member to be conveyed in the recording paper conveyance direction in close contact with the heating member, and a pressing member opposing the heating member via the belt member. The fixing device 20 nips and conveys the recording paper, carrying an image thereon, between the pressing member and the belt member to heat the image.

### 1) Heating Member

A heater unit 60 includes a heater 600 and a heater holder (heater stay) 660, as a supporting member for supporting the heater 600, formed in a semicircular trough shape in cross section. Further, the heater unit 60 includes a reverse U-shaped reinforcing metal plate 670 provided for preventing the heater unit 60 from being deformed when the heater unit 60 is pressed by a pressing roller 70 as the distributing member described later.

The heater 600 includes a substrate which extends in a direction perpendicular to the conveyance direction of the recording paper P and which has an insulating property, a heat-resistant property and a low thermal capacitance, and includes a heat generating resistor 620 and a thermistor 630. The heater 600 is fixedly supported by the heater holder 660 in a heat insulation state while exposing the heat generating resistor 620 toward the heater holder 660. Further, in a side where the heater 600 contacts and heats the fixing belt 650, as a sliding layer, an about 10 μm-thick polyimide layer is provided. By this polyimide layer, a sliding resistance between the fixing belt 650 and the heater 600 is reduced, so that a decrease in driving torque and abrasion (wearing) of the fixing belt650 at its inner surface are prevented.

### 2) Belt Member

The fixing belt 650 formed with a cylindrical heat-resistant film is prepared by forming an about 300 μm-thick silicone rubber layer (elastic layer), by a ring coating method, on a 30 μm-thick cylindrical base material of stainless steel. Further, thereon, a 20 μm-thick PFA (perfluoroethylene-perfluoroalkylvinyl ether copolymer) resin tube is coated as an outermost surface layer. The fixing belt 650 is loosely fitted around the heater holder 660.

The heater holder 660 is formed of a liquid crystal polymer (resin) having high heat resistance and perform functions of holding the heater 600 and guiding the fixing belt 650. In this embodiment, as the liquid crystal polymer, Zenite 7755 (trade name, mfd. by DuPont) was used.

The heater holder 660 is urged, at its longitudinal end portions by an unshown urging (pressing) mechanism, in an axial direction of the pressing roller 70 at a force of 156.8 N (16 kgf) in one side, i.e., at a total pressure of 313.6 N (32 kgf). As a result, a lower surface (heating surface) of the heater 600 is press-contacted to the fixing belt 650 against the elastic layer of the pressing roller 70 at a predetermined urging force (pressure), so that a fixing nip N having a predetermined width necessary for fixing is formed.

### 3) Pressing Member

Under the heater unit 60, the pressing roller 70 as the pressing member is provided in parallel to the heater unit 60, and is constituted by a core metal 71, an about 3 mm-thick elastic layer 72 of a silicone rubber, and an about 40 μm-thick surface layer 73 of a PFA resin tube. The pressing roller 70 is rotationally driven (in the counterclockwise direction) along the predetermined conveyance direction by a driving system (not shown), so that the cylindrical fixing belt 650 closely contacts and slides on the heat generating member surface to rotationally move around the heater holder 660.

Thus, the pressing roller 70 is rotationally driven in an arrow direction at a predetermined peripheral speed, and the fixing belt 650 to which the pressing roller 70 is pressed is rotated at a predetermined speed by the rotational drive of the pressing roller 70. At this time, the inner surface of the fixing belt 650 closely contacts the lower surface of the heater 600, so that the fixing belt 650 is in a state in which the fixing belt 650 is rotatable, by the rotation of the predetermined roller 70, in the arrow direction around the heater holder 660 while sliding with the heater holder 660. Onto the inner surface of the fixing belt 650, grease is applied, thus ensuring a sliding property between the heater holder and the inner surface of the fixing belt 650.

When the pressing roller 70 is rotationally driven and correspondingly thereto the fixing belt 650 is placed in the state in which the fixing belt 650 is rotatable by the rotation of the pressing roller 70, electric energy (electric power) is supplied to the heater 600. Then, in a state in which a temperature of the heater 600 is increased up to a set temperature and is controlled at the set temperature, into the fixing nip N, the recording paper P which is a sheet on which unfixed toner images are carried is guided along an entrance guide. Then, at the fixing nip N, a toner image-carrying surface of the sheet closely contacts the outer surface of the fixing belt 650, so that the sheet moves together with the fixing belt 650.

In a process in which the recording paper P is nipped and conveyed through the fixing nip N, heat from the heater is applied to the recording paper P via the fixing belt 650, the unfixed toner images are melted and fixed on the recording paper P. The recording paper P passed through the fixing nip N is separated and discharged from the fixing belt 650.

A thermistor 630 is provided at a back surface (opposite from the heating surface) of the heater 600 as a heat source and performs a function of detecting the temperature of the heater 600. The thermistor 630 is connected, via an A/D converter, to the CPU 100 which is a control circuit portion as a control means. The control circuit portion 100 effects sampling of an output from each thermistor at a predetermined period, and is constituted so as to reflect obtained temperature information in temperature control. That is, the control circuit portion 100 determines temperature control contents of the heater 600 on the basis of the output of the thermistor 630, and then controls electric energy supply to the heater 600 by a heater drive circuit portion 51 as a power supplying portion (electric energy supplying portion).

### (Heater)

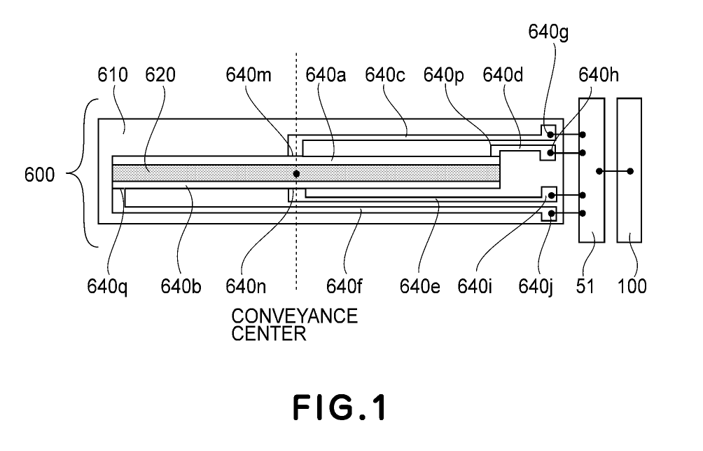

FIG. 1 is a schematic view showing an example of the heater 600, as the heating member in this embodiment, as seen from the surface side of the substrate 610. The heater 600 generates heat by applying, via a first electrode pair, a voltage to a resistor 620 (hereinafter referred to as a heat generating resistor) extending in the longitudinal direction. The first electrode pair includes first electrode regions (640a and 640b) which are electroconductive positions provided along the longitudinal direction in an upstream side and a downstream side, respectively, of the recording paper conveyance direction, and includes second end portions (640d and 640f) which are electroconductive portions each connecting from a power source to the first electrode region.

In FIG. 1, the heater 600 includes a 1.0 mm-thick high-rigidity insulating substrate 610 formed of a heat-resistant and electrically insulating material, such as alumina (Al₂O₃) exhibiting high heat conduction, in an elongated flat plate shape. Onto the substrate 610, an electroconductive paste such as ruthenium oxide (RuO₂) having a relatively high resistance value was uniformly applied in parallel along the longitudinal direction of the substrate 610 in a film thickness of about 10 μm by a screen printing method.

The electroconductive paste was baked to form the layer of the heat generating resistor 620 having a volume resistivity of 1000 Ω/sq, so that the heat generating resistor 620 was fixed on the substrate 610. Incidentally, the heat generating resistor 620 may also be a sintered molded member of a self-temperature control type, such as barium titanate having a positive resistance temperature characteristic (PTC). The substrate 610 of about 330 mm in longitudinal length and about 10 mm in widthwise width was used in this embodiment. Further, the heat generating resistor 620 was about 300 mm in longitudinal length an about 4.0 mm in widthwise width, and was provided on the substrate 610 so that its longitudinal center position was aligned with a conveyance center line of the recording paper P.

### (Wiring Pattern as First Electrode Region and Connecting Pattern as Second Electrode Region)

### 1) First Electrode Pair

With respect to the heat generating resistor 620, wiring patterns (electroconductive portions) 640a and 640b as the first electrode regions provided along the longitudinal direction in upstream and downstream sides, respectively, of the recording paper conveyance direction are disposed. Further, connecting patterns (end electric energy supply paths) 640d and 640f as the second electrode regions each connecting from the power source to the first electrode region are provided. The second electrode regions also include, in addition to the connecting patterns 640d and 640f, connecting patterns extending to connecting positions 640p and 640q where the connecting patterns are connected to the first electrode regions. These connecting positions 640p and 640q are displaced in the longitudinal direction and are disposed to establish point symmetry with respect to the center of the heat generating resistor in this embodiment.

Each of the patterns was prepared by screen-printing on the substrate, a paste of an electroconductive material, such as Ag or Ag/Pt, mixed with glass powder, and by changing a mixing ratio of the glass powder to the electroconductive material, the volume resistivity was made adjustable. In this embodiment, as the above-described pattern, a 10 μm-thick pattern having an adjusted volume resistivity of 10 mΩ/sq was used. The electroconductive material was disposed along the longitudinal direction of the heat generating resistor 620 to form the wiring patterns 640a and 640b.

### 2) Second Electrode Pair

With respect to the heat generating resistor 620, wiring patterns (electroconductive portions) 640a and 640b as the first electrode regions provided along the longitudinal direction in upstream and downstream sides, respectively, of the recording paper conveyance direction are disposed in common to the first and second electrode pairs. Further, connecting patterns (central electric energy supply paths) 640c and 640e as the second electrode regions each connecting from the power source to the first electrode region are provided. The second electrode regions also include, in addition to the connecting patterns 640c and 640e, connecting patterns extending to connecting positions 640m and 640n where the connecting patterns are connected to the first electrode regions.

The end 640m of the connecting pattern 640c was integrally connected to the longitudinal central portion of the wiring pattern 640a at the conveyance center position of the recording paper P, and another end of the connecting pattern 640c was integrally connected to an electrode 640g. On the other hand, the end 640n (opposing the end 640m at the longitudinal central portion) of the connecting pattern 640e was integrally connected to the longitudinal central portion of the wiring pattern 640b at the conveyance center position of the recording paper P, and another end of the connecting pattern 640e was integrally connected to an electrode 640b.

Each of the wiring patterns 640a and 640b is disposed to extend along the longitudinal direction of the heat generating resistor 620, from the end to another end of the heat generating resistor 620 with a width of about 1.0 mm. Further, each of the connecting patterns 640c, 640d, 640e and 640f is integrally connected to the wiring pattern 640a or 640b with a width of about 3.0 mm with respect to the longitudinal direction. Further, the connecting patterns 640c, 640d, 640e and 640f are integrally connected to electrodes 640g, 640h, 640i and 640j, respectively, in parallel with respect to the longitudinal direction with a width of about 1.0 mm with respect to the longitudinal direction. Further, the patterns are arranged so that a widthwise interval between adjacent patterns of the connecting patterns and the wiring patterns is 1.0 mm or more.

Incidentally, although having not illustrated in FIG. 1, the heat generating resistor 620 partly overlaps with each of the wiring patterns 640a and 640b with respect to the longitudinal direction. In this case, at the overlapping portion, the heat generating resistor 620 is disposed on each of the wiring patterns 640a and 640b but may also be disposed under each of the wiring patterns 640a and 640b.

The heater in this embodiment is a ceramic heater prepared by coating, with a pressure-resistant glass material (not shown), the heat generating resistor 620, the wiring patterns and the connecting patterns which are formed on the substrate 610. Into the glass material, an inorganic oxide filler, such as alumina, excellent in heat conduction, is added in an amount of 25-35 wt. % so as to provide a coating layer thickness of about 20-100 pm and thermal conductivity of, e.g., 2 W/m.K or more, thus forming an overcoat layer improved in sliding property. By this gloss (material) coating, the heat generating resistor, the wiring patterns and the connecting patterns can be protected mechanically, chemically and electrically.

Each of the electrodes 640g, 640h, 640i and 640j is formed in a longitudinal length of 2.0 mm and a widthwise width of 2.0 mm and can be connected to the control circuit portion (CPU) 100 via a connector for electric energy supply. Therefore, the CPU supplies electric power (electric energy) as described later by switching a power source between associated electrodes depending on a widthwise size of the recording paper or an output of the thermistor for detecting the temperature of the heater.

In this embodiment, a switch for switching, by the control circuit portion 100 functioning as a selector, a mechanism for supplying the electric power between the electrodes 640g and 640i (central portion electric energy supply) and a mechanism for supplying the electric power between the electrodes 640h and 640j (end portion electric energy supply) is incorporated. That is, electric energy supply and non-electric energy supply are switched so that when one of the central portion electric energy supply and the end portion electric energy supply is effected, another one is not effected.

### (Heat-Fixing Operation)

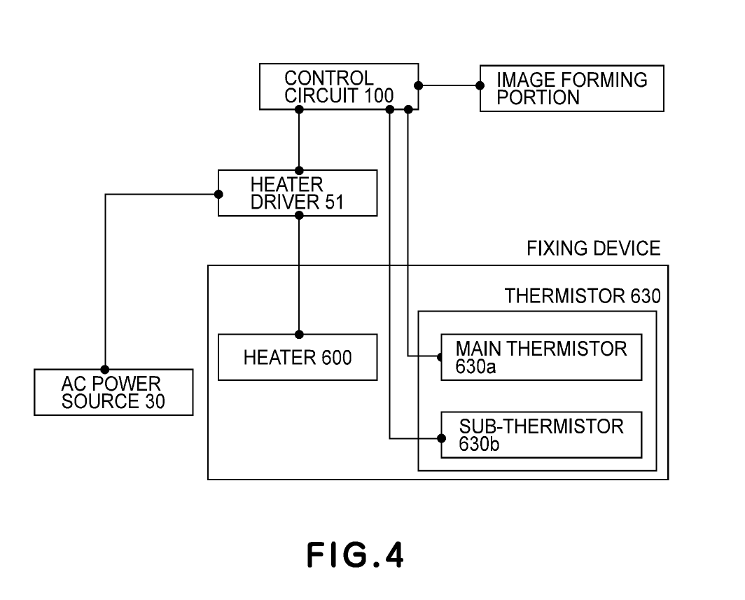

FIG. 4 is a block diagram in this embodiment. Operations of the fixing device and the image forming portions are controlled by the control circuit portion including the CPU and a memory. A user transfers print data to the image forming apparatus by using an unshown general-purpose interface, thus providing an image output instruction (command). When the image output instruction is provided, the control circuit portion 100 transfers an image formation instruction (command) and image data to the image forming portions, and sends a heat-fixing operation instruction to the fixing portion. As the heat-fixing operation, the control circuit portion 100 turns on a triac 51 as an electric energy supply control means.

As a result, the electric energy is supplied to the heat generating resistor 620 through a path from an AC power source 30 to each of the electrodes 640g, 640i, 640h and 640j of the heater 600. Then, the heat generating resistor 620 generates heat to heat the substrate 610, so that the entire heater 600 is quickly increased in temperature. The temperature of the thus heated heater 600 is detected by the thermistor 630. The control circuit portion 100 obtains an output (detected temperature) of the thermistor 630 through A/D conversion.

Then, on the basis of an output from the thermistor 630, the control circuit portion 100 controls the electric power supplied to the heater 600 by the triac 51 through phase control, wave number control, or the like, thus effecting temperature control of the heater. That is, the control circuit portion 100 controls, during a step in which the toner image on the recording paper P is heat-fixed, the electric energy supply to the heater 600 so that the detected temperature by the thermistor 630 can be kept at a set temperature (target temperature). That is, the control circuit portion 100 temperature-controls the heater 600 at the set temperature by controlling the electric energy supply so that the heater 600 is increased in temperature in the case where the detected temperature by the thermistor 630 is lower than a predetermined set temperature and so that the heater 600 is decreased in temperature in the case where the detected temperature by the thermistor 630 is higher than the predetermined set temperature.

The set temperature during the fixing is set by the control circuit portion 100 depending on a degree of warming, of the pressing roller 70, which can be estimated by counting a print number during continuous printing or by counting a time during the continuous printing) or depending on the type of the recording paper P (plain paper, thick paper, resinous sheet, etc.) or the like. Accordingly, the printer in this embodiment is capable of setting a plurality of set temperatures depending on the type of the recording paper P.

Thus, in a state in which the rotations of the pressing roller 70 and the fixing belt 650 and the electric energy supply to the heater 600 are carried out, the recording paper P carrying thereon the unfixed toner image is introduced into the nip N with the toner image-carrying surface upward. The recording paper P ripped and conveyed together with the fixing belt 650 at the nip N, so that heat energy of the heater 600 contacting the inner surface of the fixing belt 650 at the nip N is applied to the recording paper P via the fixing belt 650. Then, by the pressure at the nip N, heat-pressure fixing of the toner image is made.

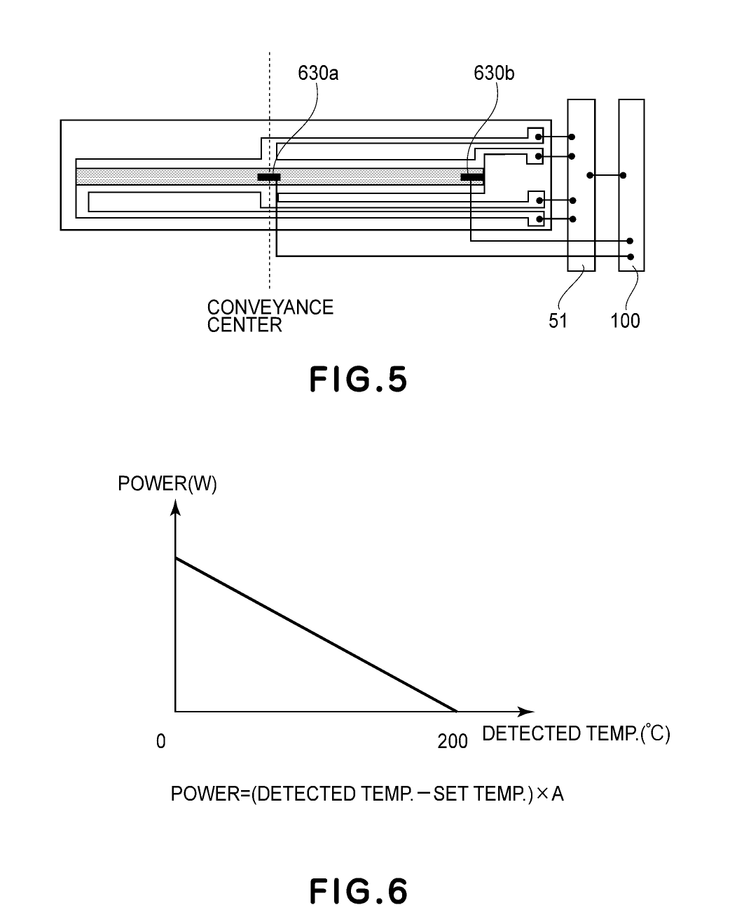

In this embodiment, the thermistors 630 were disposed at positions as shown in FIG. 5 to detect the temperature of the heater 600 at a central portion and an end portion, so that the electric energy supply control of the heater 600 was effected. That is, in order to detect the temperature of the heat generating resistor 620 at the central portion, at a longitudinal central position of the heat generating resistor 620, a main thermistor 630a was provided in contact with the heat generating resistor 620. Further, in order to detect the temperature of the heat generating resistor 620 at the end portion, at a longitudinal end position of the heat generating resistor 620, a sub-thermistor 630b was provided. Each of the thermistors is connected to the control circuit portion 100 and detects the temperature, thus effecting the temperature control so that the detected temperature is a desired set temperature.

### (Temperature Control of Fixing Device)

Next, temperature control of the fixing device by the control circuit portion 100 (electric energy supply control of the heater) will be described. In this embodiment, on the basis of a temperature detection result of the thermistors 630 provided on the back surface of the heat generating resistor 620, the temperature control of the fixing belt 650 is effected. That is, as shown in FIG. 6, control such that electric power proportional to deviation (temperature difference) between the detected temperature by the thermistor 630 and the target temperature is applied to the heater 600 is effected. Incidentally, this control system is referred to as a proportional control system. However, the control system is not limited thereto but other control systems such as a so-called PID control system and the like can also be employed.

Incidentally, with respect to the toner used in this embodiment, in the case where the recording paper having a basis weight of 64 g/m² is used, when the temperature of the fixing belt is 220° C. or more, a so-called hot offset occurs. Further, in the case where the recording paper having a basis weight of 105 g/m² is used, when the fixing belt temperature is 180° C. or less, a so-called cold offset occurs, so that an image quality is remarkably impaired. Accordingly, in order to prevent the fixing belt temperature from being increased up to the above-described temperature, temperature control described later is effected.

### (Longitudinal Temperature Distribution)

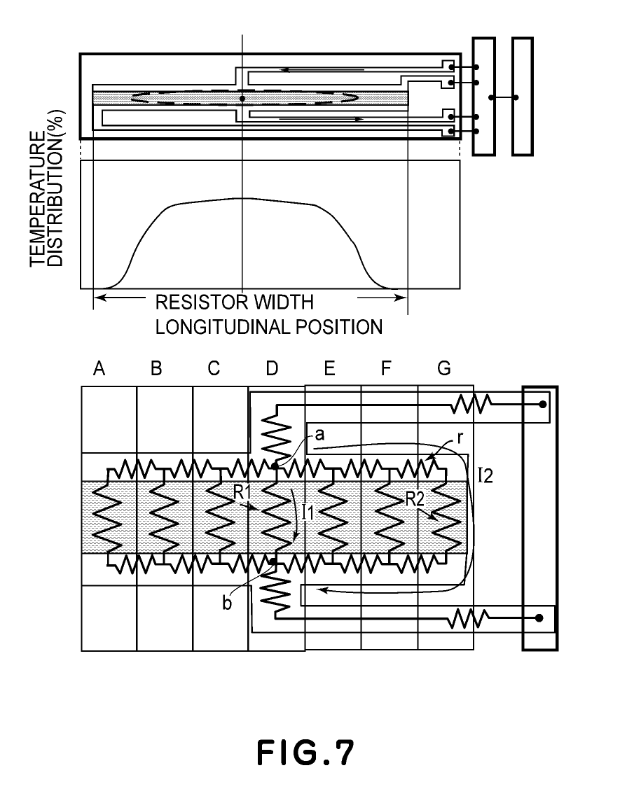

Here, in the above-described constitution in this embodiment, a temperature distribution in the case where the electric power is supplied by each of the central portion electric energy supply (between the electrodes 640g and 640i) and the end portion electric energy supply (between the electrodes 640h and 640j) will be described. FIG. 7 shows a result, measured by thermography, of a longitudinal temperature distribution in the case where the electric power is supplied by the central portion electric energy supply (between the electrodes 640g and 640i) and is set so that the detected temperature by the main thermistor 630a is kept at 200° C. Further, at a lower part of FIG. 7, a circuit diagram schematically drawn for illustrating a current passing through the heat generating resistor 620 in the central portion electric energy supply.

A model shown at the lower part of FIG. 7 shows wiring and connecting patterns and resistors in a region in which the heater is divided into 7 areas while keeping the same positional relationship with the upper part of FIG. 7. In FIG. 7, a dark portion (dotted region) represents the heat generating resistor 620. Here, in FIG. 7, a pressing (resistance value) of the heat generating resistor 620 in area D is R1, and a resistor of the heat generating resistor 620 is R2 which is considered as being substantially equal to R1. Further, a resistor of the wiring pattern is r.

In the case of the central portion electric energy supply, as shown in the temperature distribution result of FIG. 7, the current passing through the heat generating resistor 620 readily flows adjacent to the connecting position between the connecting pattern 640c and the wiring pattern 640a and the connecting position between the connecting pattern 640e and the wiring pattern 640b (broken line region at the upper part of FIG. 7). That is, it is understood that an amount of heat generation adjacent to the central portion is larger than that at end portions and thus the temperature distribution is such that the temperature at the central portion is high. When this is explained with reference to the circuit diagram in FIG. 7, a current I1 passing through the resistor R1 from branch point a to branch point b does not pass through the resistor r of the wiring pattern but passes through the resistor R1. On the other hand, a current I2 passes through the resistor R2 after passing through three resistors r of the wiring pattern.

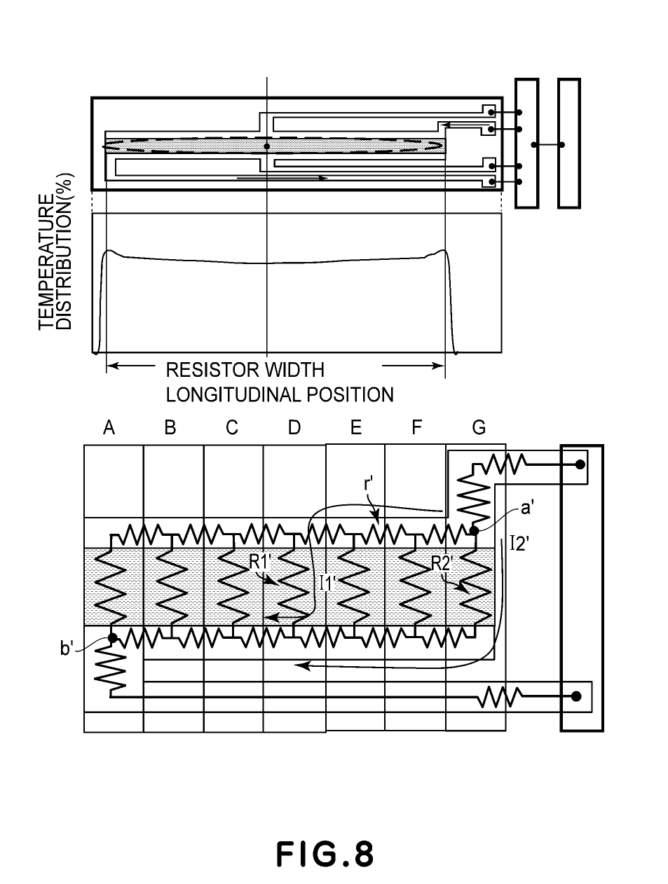

Therefore, an amount of the current I2 passing through the resistor R2 is lower than that of the current I1 passing through the resistor R1 due to voltage drop by the wiring pattern resistors r (I1>I2), and as a result, it is understood that the amount of the heat generating resistor is decreased (I1²×R1>I2²×R2). Accordingly, the central portion electric energy supply is suitable for the case where the temperature adjacent to the central portion is intended to be increased or the case where the end portion temperature is intended to be decreased, so that its effect appears during non-sheet-passing portion temperature rise occurring when the sheets of the small-sized paper are continuously passed through the fixing device. Similarly, FIG. 8 shows a result, measured by the above-described method, of a longitudinal temperature distribution in the case where the electric power is supplied by the end portion electric energy supply (between the electrodes 640h and 640j). Further, at a lower part of FIG. 8, a circuit diagram schematically drawn for illustrating a current passing through the heat generating resistor 620 in the end portion electric energy supply. A pressing (resistance value) of the heat generating resistor 620 in area D is R1′, and a resistor of the heat generating resistor 620 is R2′ which is considered as being substantially equal to R1′. Further, a resistor of the wiring pattern is r′.

In the case of the end portion electric energy supply, as shown in FIG. 8, the current passing through the heat generating resistor 620 flows between the connecting patterns 640d and 640f (broken line region at the upper part of FIG. 8). That is, it is understood that although the current passes through the entire region but the temperature adjacent to the connecting position becomes high and thus the longitudinal temperature distribution is such that the temperature at each of the end portions is higher than that at the central portion. When this is explained with reference to the circuit diagram in FIG. 8, a current I1′ passing through the resistor R1 from branch point a′ to branch point b′ passes through the resistor R1 after passing through the three resistors r′ of the wiring pattern. On the other hand, a current I2′ does not pass through the resistor r′ of the wiring pattern but passes through the resistor R2.

Therefore, an amount of the current I2′ passing through the resistor R2′ is lower than that of the current I1′ passing through the resistor R1′ due to voltage drop by the wiring pattern resistors r′ (I1′<I2′), and as a result, it is understood that the amount of the heat generating resistor is decreased (I1′²×R1′<I2′²×R2′).

Accordingly, the end portion electric energy supply is suitable for the case where the temperature at the end portion is intended to be increased, so that its effect appears during end portion temperature change in the case where the sheets of the maximum-sized paper are continuously passed through the fixing device. The temperature change is a phenomenon such that when the fixing operation is started in a low temperature state of the pressing roller 70, heat generated by the heater 600 is partly absorbed by the pressing roller 70 via the fixing belt 650 to be conducted to the longitudinal end portions of the pressing roller 70 and thus the longitudinal temperature distribution in which the end portion temperature is low. When the temperature non-uniformity occurs, in the case of the sheet passing of the maximum-sized paper, due to the low end portion temperature, an output image is influenced as improper fixing (cold offset, uneven glossiness or the like).

### (Switching Between Central Portion Electric Energy Supply and End Portion Electric Energy Supply)

Next, an example of timing of switching between the central portion electric energy supply and the end portion electric energy supply by the control circuit portion 100 will be described.

a) Case where Countermeasure Against Non-Sheet-Passing Portion Temperature Rise is Taken

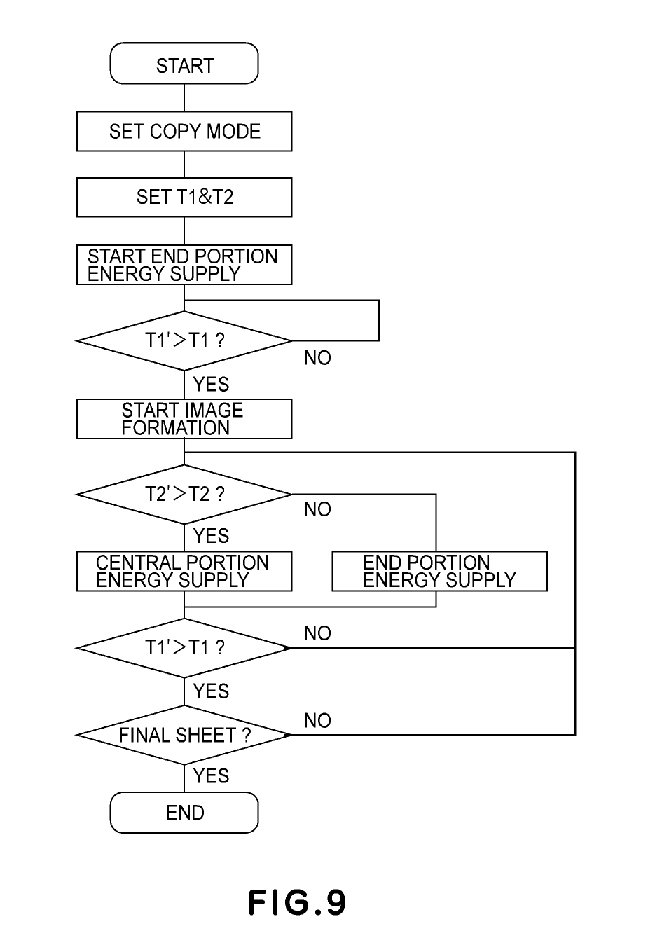

FIG. 9 is a flow chart of temperature control in the case where the end portion temperature rise is detected by the sub-thermistor 630 for detecting the longitudinal end portion temperature (that is, during continuous sheet passing of the small-sized paper liable to cause the non-sheet-passing portion temperature rise). Here, a target temperature of the main thermistor 630a is T1, and a detected temperature by the main thermistor 630a is T1′. A target temperature of the sub-thermistor 630b is T2, and a detected temperature by the sub-thermistor 630b is T2′.

In this embodiment, depending on a value of a difference between the detected temperature T2′ by the sub-thermistor 630b and the target temperature T2 set for the sub-thermistor 630b, the electric power supply is switched between the central portion electric energy supply (between the electrodes 640g and 640i) and the end portion electric energy supply (between the electrodes 640h and 640j) to effect temperature control. Incidentally, the target temperatures T1 and T2 of the main thermistor 630a and the sub-thermistor 630b are stored in a non-volatile memory as a storing means, and these data are read as desired by the control circuit portion 100.

When the control circuit portion 100 receives a signal of an operation job, setting of a copying mode is made. In this setting step of the copying mode, the type and size of the recording paper used for image formation are set. In this embodiment, the case where a paper mode is a plain paper mode will be described. When the setting of the recording paper is made, depending on the paper mode, the target temperature T1 for the main thermistor 630a and the target temperature T2 for the sub-thermistor 630b are set. On the basis of the thus-set target temperatures, the electric energy supply to the heater 600 is started. In this embodiment, the temperature of the heater 600 in the entire region is increased at the time of starting the electric energy supply, and therefore the temperature control is effected by the end portion electric energy supply.

Here, when the detected temperature T1′ by the main thermistor 630a exceeds the target temperature T1, an image forming operation is started. In this case, various timing values are set so that the sheet reaches the fixing nip at timing when the detected temperature T1′ by the main thermistor 630a reaches the target temperature T1. When the image forming operation is started, the temperature in the sheet passing region where the recording paper is to be conveyed changes adjacent to the target temperature T1 but temperature rise occurs at a non-sheet-passing portion other than the sheet passing region.

Therefore, in the case where the temperature is detected by the sub-thermistor 630b during the sheet passing and reaches the target temperature T2 of the sub-thermistor 630b, the switch is switched by the control circuit portion 100 so that the electric energy supply is changed from the end portion electric energy supply to the central portion electric energy supply. This switching operation is performed on the basis of detection by each of the thermistors until the image forming operation based on the inputted job signal is ended. Further, as described later, in the case where the end portion temperature is increased by the above temperature control when the small-sized sheet passing is made, it becomes possible to reduce a degree of the non-sheet-passing portion temperature rise by switching of the electric energy supply to the central portion electric energy supply.

b) Case where Degree of Longitudinal Temperature Non-Uniformity is Alleviated

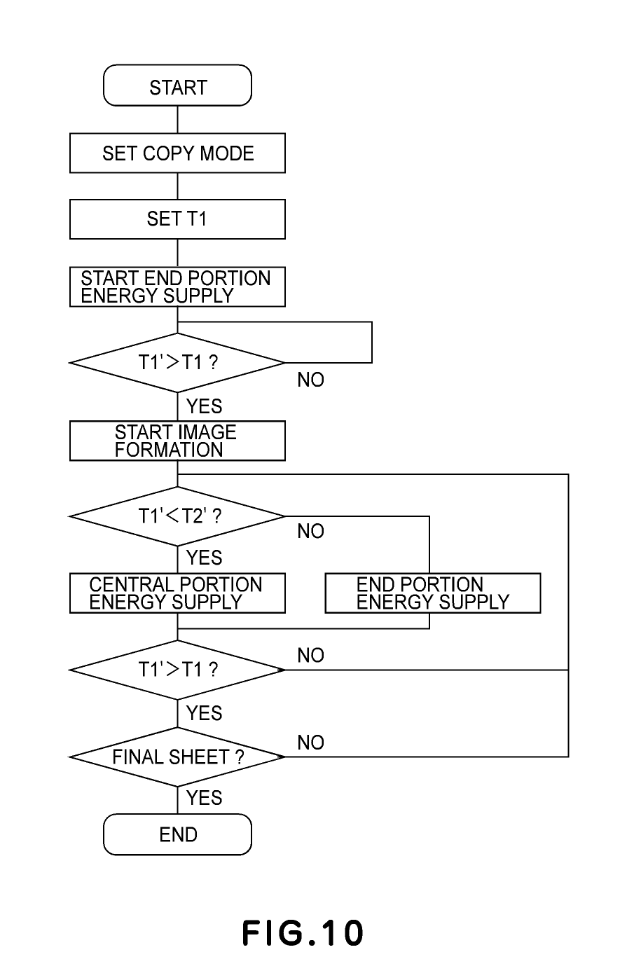

In this embodiment, depending on the longitudinal distribution, e.g., depending on a value of a difference between the detected temperatures by the main thermistor 630a and the sub-thermistor 630b, the electric power supply between the central portion electric energy supply (between the electrodes 640g and 640i) and the end portion electric energy supply (between the electrodes 640j is switched. A flow chart of such temperature control is shown in FIG. 10.

In this embodiment, until the start of the image formation, the sequence is the same as the case of a) described above. In this embodiment, a difference between the detected temperature T1′ by the main thermistor 630a and the detected temperature T2′ by the sub-thermistor 630b during the sheet passing is always read, and then the control circuit portion 100 discriminates whether the electric energy supply should be changed to the central portion electric energy supply or the end portion electric energy supply, thus effecting the electric power switching. The fixing operation is performed by the end portion electric energy supply in the case of T1′>T2′, and is performed by the central portion electric energy supply in the case of T1′<T2′. As described later, in the case where sheets of the recording papers having different sizes are continuously passed or the like case, the degree of the longitudinal temperature non-uniformity is alleviated by the temperature control described above, so that a degree of the image defect caused by the longitudinal temperature non-uniformity can be reduced.

Further, in this embodiment, the temperature control using the two thermistors is described as an example but three or more thermistors may also be used. By disposing the above-described thermistors at a plurality of positions, the longitudinal temperature non-uniformity in the case where various sheets having different paper sizes are subjected to the sheet passing can be prevented.

### Comparison Example 1

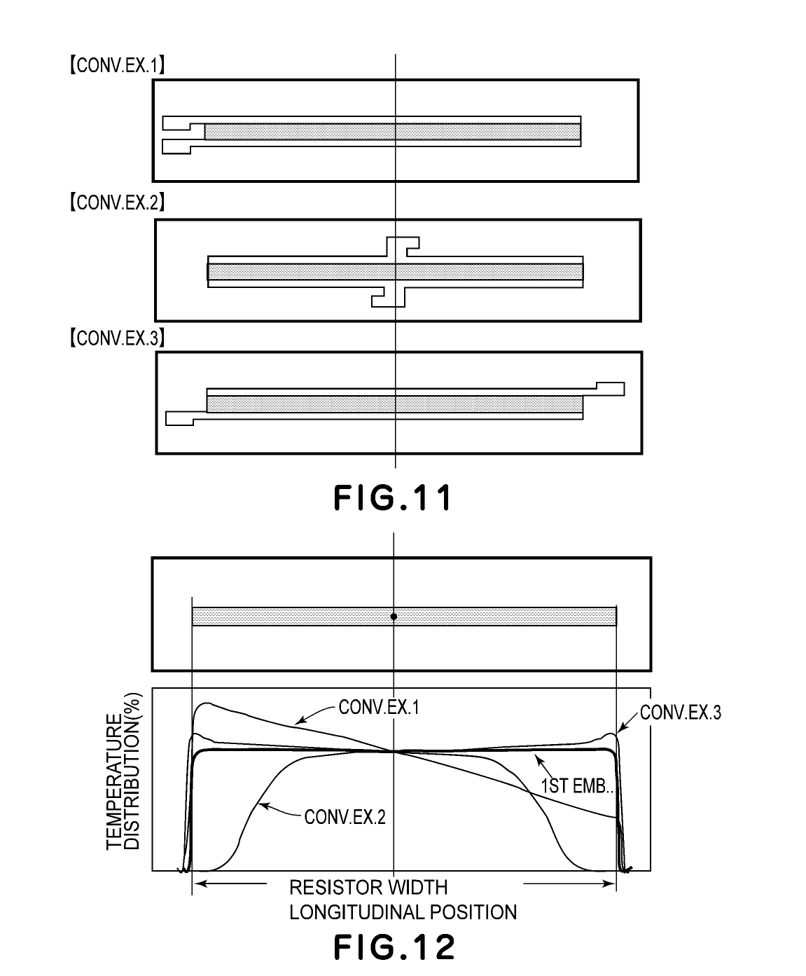

An experimental result of comparison in which the temperature distribution of the heat generating resistor with respect to the longitudinal direction of the heater in the case where the temperature control in the constitution in First Embodiment is effected is compared with those in the cases (Conventional Examples 1 to 3) where a conventional widthwise electric energy supply type heater is used will be described below. FIG. 11 shows constitutions of the conventional widthwise electric energy supply type heaters in Conventional Examples 1 to 3. In FIG. 11, shapes (width, length and thickness) of the heat generating resistors 620 and shapes of the wiring patterns are the same as those in First Embodiment but positions of the connecting patterns are changed from those in First Embodiment. Conventional Example 1 employs the constitution in the case where the connecting patterns are connected to the heat generating resistor at an end portion of the heat generating resistor. Conventional Example 2 employs the constitution in the case where the connecting patterns are connected to the heat generating resistor at the central portion of the heat generating resistor along the center line of the conveyance direction of the recording paper P.

Conventional Example 3 employs the constitution in the case where the connecting patterns are connected to the heat generating resistor at symmetrical end portions with respect to the center of the heat generating resistor. In FIG. 11, with respect to each of the heaters, a result of longitudinal temperature non-uniformity measured by the thermography when the electric energy is supplied to the heater at a voltage of 120 V so that the temperature reaches 200° C. is shown. The temperature control was effected so that the detected temperature by the main thermistor at the central portion was kept at 200° C. Incidentally, in the case of FIG. 11, the recording paper sheet passing is not performed.

The experimental result described above is shown in FIG. 12. In Conventional Example 1, it is understood that the amount of heat generation at the longitudinal end portion constituting the connecting patterns is large and thus the temperature distribution is such that the temperature is decreased from the longitudinal end portion (connecting pattern) side toward another longitudinal end portion side. In Conventional Example 2, the result was such that the heat is principally generated at the central portion but is little generated at the end portions. In Conventional Example 3, the temperatures at the end portions become high. Compared with these conventional examples, in First Embodiment, it is understood that a degree of the temperature non-uniformity is small at both of the central portion and the end portions and thus a uniform temperature is kept with respect to the longitudinal direction.

### Comparison Example 2

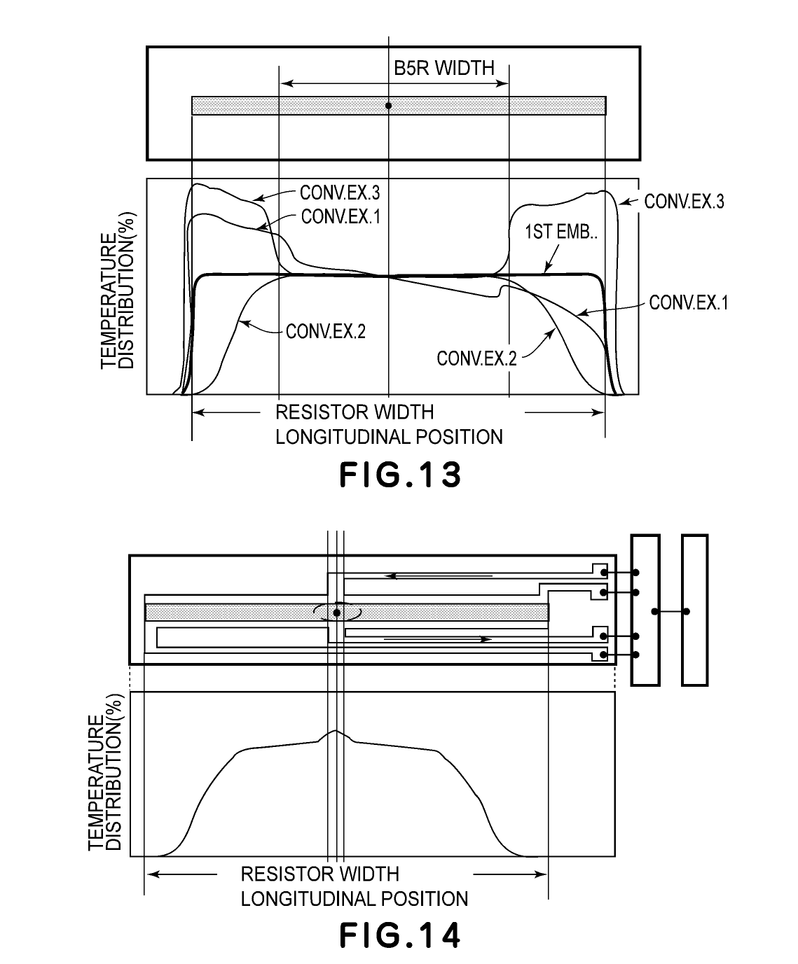

In this comparison example, comparison between First Embodiment and Conventional Examples 1 to 3 in the case where sheets of the recording paper are actually subjected to the sheet passing was made. A result of a longitudinal temperature distribution measured by the thermography immediately after 1000 sheets of the small-sized paper (B5R feeding with a white image) is shown in FIG. 13. Further, a result of observation of states during and after the continuous sheet passing of 1000 sheets is shown in Table 1 below.

A degree of the non-sheet-passing portion temperature rise was evaluated as follows. represents the case where the temperature measured by the thermography at the non-sheet-passing portion during the sheet passing exceeded 240° C. “Δ” represents the case where the temperature exceeded 240° C. only in one end portion side. “o” represents that there was of no particular problem. An image was evaluated in a manner such that the continuous sheet passing of 1000 sheets was made and immediately thereafter a maximum-sized (A3-sized) paper on which a solid toner image was formed was subjected to the sheet passing to observe the toner image on the recording paper by eyes, and then the toner image was evaluated based on whether or not the improper fixing such as the cold offset, the hot offset or the uneven glossiness was generated. “x” represents that the improper fixing was generated, and “o” represents that there was of no particular problem.

TABLE 1

| ITEM | FE*² | CE1*³ | CE2*⁴ | CE3*⁵ |
|---|---|---|---|---|
| NSPPTR*¹ | ∘ | Δ | ∘ | x |
| IMAGE | ∘ | x | x | x |

*¹“NSPPTR” represents the non-sheet-passing portion temperature rise.
*²“FE” represents First Embodiment.
*³“CE1” represents Conventional Example 1.
*⁴“CE2” represents Conventional Example 2.
*⁵“CE3” represents Conventional Example 3.

In summary, in Conventional Example 1, the temperature rise in the connecting pattern side was conspicuous and the temperature was increased to the neighborhood of a machine failure temperature. Further, in the side opposite from the connecting pattern side, the temperature lowering occurred, so that the cold offset was generated. In Conventional Example 2, the temperature at the non-sheet-passing portion fallen within a low temperature level, but when the sheet passing of the maximum-sized paper was performed, the temperature difference was generated between the central portion and the end portions of the recording paper and thus an end portion image deterioration (cold offset, density non-uniformity, uneven glossiness) was generated.

In Conventional Example 3, the temperature rise at the longitudinal end portions appeared conspicuously, with the result that the so-called non-sheet-passing portion temperature rise occurred and the fixing device was broken down. Further, the temperature at the non-sheet-passing portion was high, and in the case where the maximum-sized paper was subjected to the sheet passing, differences in density and glossiness of the solid image became large between inside and outside of edges of the B5-sized paper (B5R feeding), so that the image deterioration was conspicuous generated. Compared with Conventional Examples 1 to 3, in First Embodiment, it was confirmed that a substantially uniform temperature distribution was obtained in the entire longitudinal region even during the sheet passing and thus a stable image can be outputted.

Incidentally, with respect to the toner used in First Embodiment, it has already been known that a good image is capable of being outputted by satisfying the fixing temperature of 200° C.±20° C. in the fixing device in the constitution in First Embodiment, so that in the constitution in First Embodiment, the good image was capable of being outputted in the entire longitudinal region under the above-described condition irrespective of the sheet size.

### Second Embodiment

In this embodiment, basic constitutions of the image forming portions and the fixing device are the same as those in First Embodiment, and constitutions of the wiring patterns and the connecting patterns which are connected to the heat generating resistor 620 are different from those in First Embodiment. In First Embodiment, the constitution in which the electric energy supply to the heat generating resistor 620 is switched between the central portion electric energy supply and the end portion electric energy supply to suppress the longitudinal temperature non-uniformity was employed.

In this embodiment, the occurrence of the temperature non-uniformity in the case where the fixing operation is performed for a long time by using the central portion electric energy supply in First Embodiment is taken into consideration. That is, when longitudinal coordinates of the connecting positions of the connecting patterns with the wiring patterns are aligned (with respect to the widthwise direction), as shown by a broken line portion in FIG. 14, a current passes through the connecting portion in a larger amount than at least another portion, so that the temperature adjacent to the connecting portion somewhat causes the longitudinal temperature non-uniformity. This is because the resistance of an electroconductor at the connecting portion between the wiring pattern and the connecting pattern is lower than that at another portion, so that the current easily passes through the connecting portion.

Further, this temperature non-uniformity is about several ° C. (several %) in terms of a change, but in these days in which a high image quality is required, there is a possibility that the temperature non-uniformity appears as the image deterioration. Therefore, in this embodiment, a constitution in which the temperature rise at the connecting position between the wiring pattern and the connecting pattern is suppressed to obtain a further uniform temperature distribution is employed.

### (Heater)

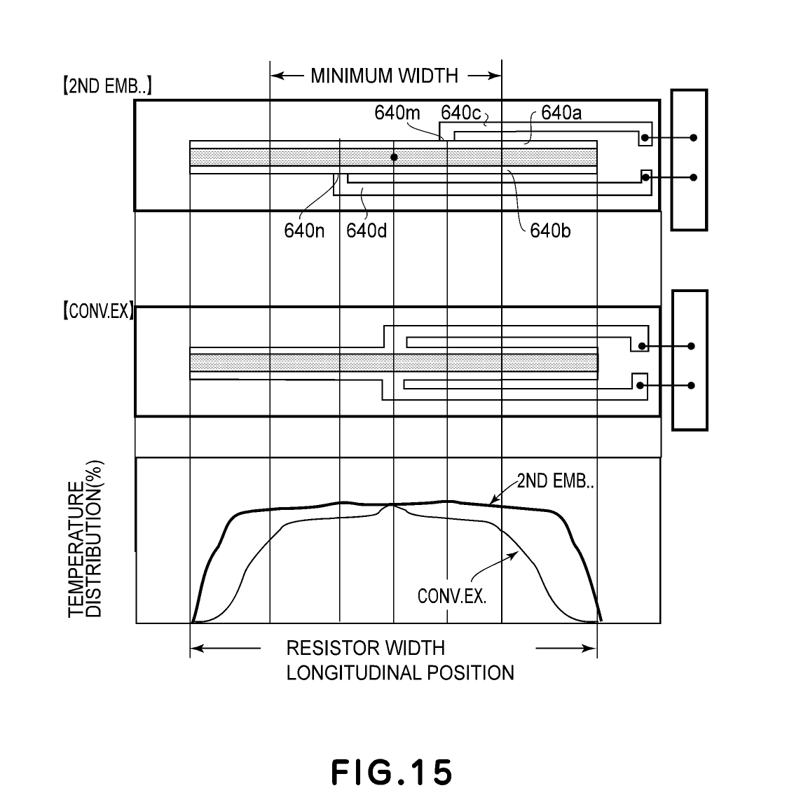

FIG. 15 includes schematic views for illustrating a comparison of a heater constitution in this embodiment with the conventional central portion electric energy supply constitution. In this embodiment, to the wiring patterns 640a and 640b, the connecting patterns 640c and 640d are connected at the connecting positions 640m and 640n, respectively, which are displaced in the longitudinal direction. Further, the connecting positions 640m and 640n are equidistant from the conveyance center (line), and are located so that an amount of longitudinal displacement is smaller than a minimum sheet passing width. For example, in the case where a minimum sheet passing size is a post card size, the connecting positions are provided within the post card size width so as to be deviated from each other with respect to the longitudinal.

Incidentally, the connecting positions 640m and 640n may also be out of symmetry with respect to the conveyance center but may only be required to be deviated from each other within a longitudinal range of the heat generating resistor.

(Comparison of Temperature Distribution Between Electric Energy Supply in this Embodiment and Conventional Central Portion Electric Energy Supply)

In FIG. 15, a result, measured by the thermography, of the temperature distribution immediately after the temperature is controlled for a long time (1 hour in this case) so that the detected temperature by a central main thermistor is kept at 200° C. by using each of the electric energy supply in this embodiment and the conventional central portion electric energy supply is shown.

As shown in FIG. 15, in the constitution in which the longitudinal coordinates of the connecting positions are aligned as in the conventional central portion electric energy supply, the amount of the current passing through the connecting positions was large, with the result that the temperature was increased and caused the temperature non-uniformity adjacent to the central portion. However, as in this embodiment, in the case where the coordinates of the connecting positions are deviated from each other within the longitudinal range of the heat generating resistor, the current passing through the heat generating resistor 620 does not concentrate between the pair of electrodes but flows in the longitudinal direction in a dispersion manner, and therefore it is understood that the temperature non-uniformity is alleviated.

### (Relationship Between Connecting Position and Minimum Sheet Passing Width)

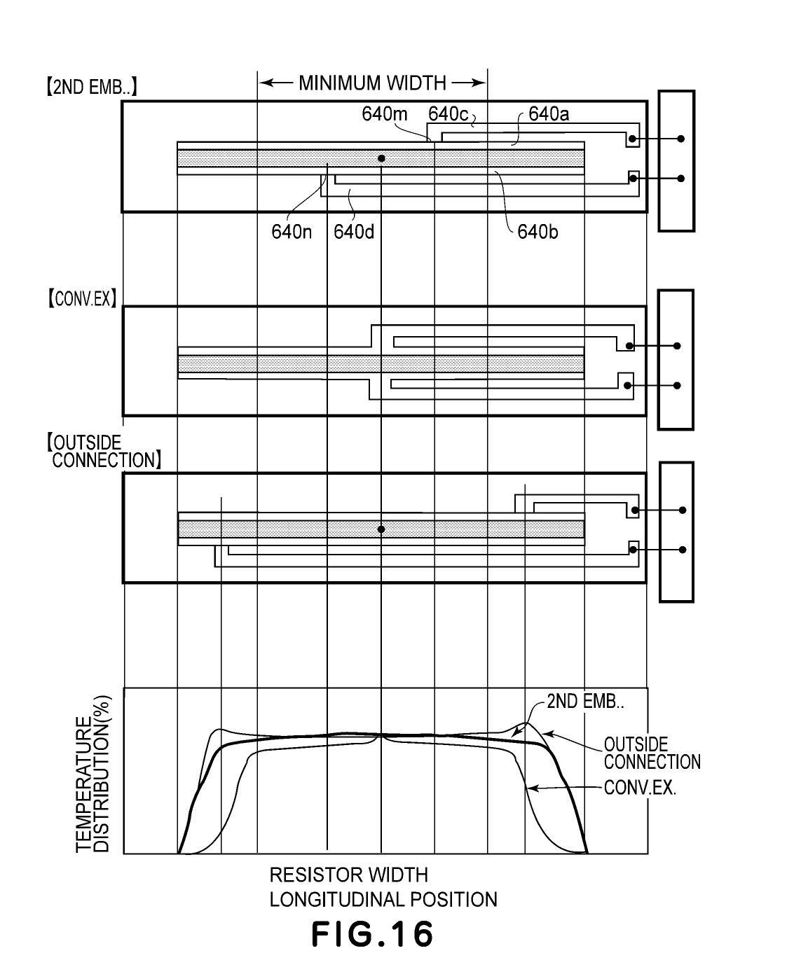

FIG. 16 includes schematic views showing a result of operation check of three types of heaters consisting of a heater in this embodiment in which the connecting positions 640m and 640n are set within the minimum sheet passing width, a heater of the conventional central portion electric energy supply type, and a heater in which the connecting positions 640m and 640n are set out of the minimum sheet passing width. The operation check of each heater is made by measuring the temperature distribution by the thermography after 1000 sheet of the post card as a minimum passable size paper are passed through the fixing device in the image forming apparatus in this embodiment.

As shown in FIG. 16, in this embodiment, the connecting positions are set within the minimum sheet passing width during the image forming operation, so that the recording paper passes through at least the connecting positions, and therefore the heat is absorbed and uniformized by the recording paper and thus the temperature non-uniformity within the recording paper width is further alleviated. However, when the connecting positions are set outside the minimum sheet passing width, in the case where the minimum-sized paper is passed through the fixing device, a non-sheet-passing portion does not contact the recording paper to cause the temperature rise, and therefore the longitudinal temperature non-uniformity is generated and when the maximum-sized paper is passed immediately after the sheet passing of the minimum-sized paper, uneven glossiness occurs. Further, in this embodiment, the connecting positions are disposed symmetrically with respect to the conveyance center, so that a symmetrical temperature distribution is obtained and thus the heater 600 can be efficiently heated.

From the above results, it is possible to reduce a degree of the longitudinal temperature non-uniformity by disposing the connecting positions, of the wiring patterns with the connecting patterns, within the minimum sheet passing width while shifting the longitudinal coordinates of thereof.

(Modified Embodiment of this Embodiment)

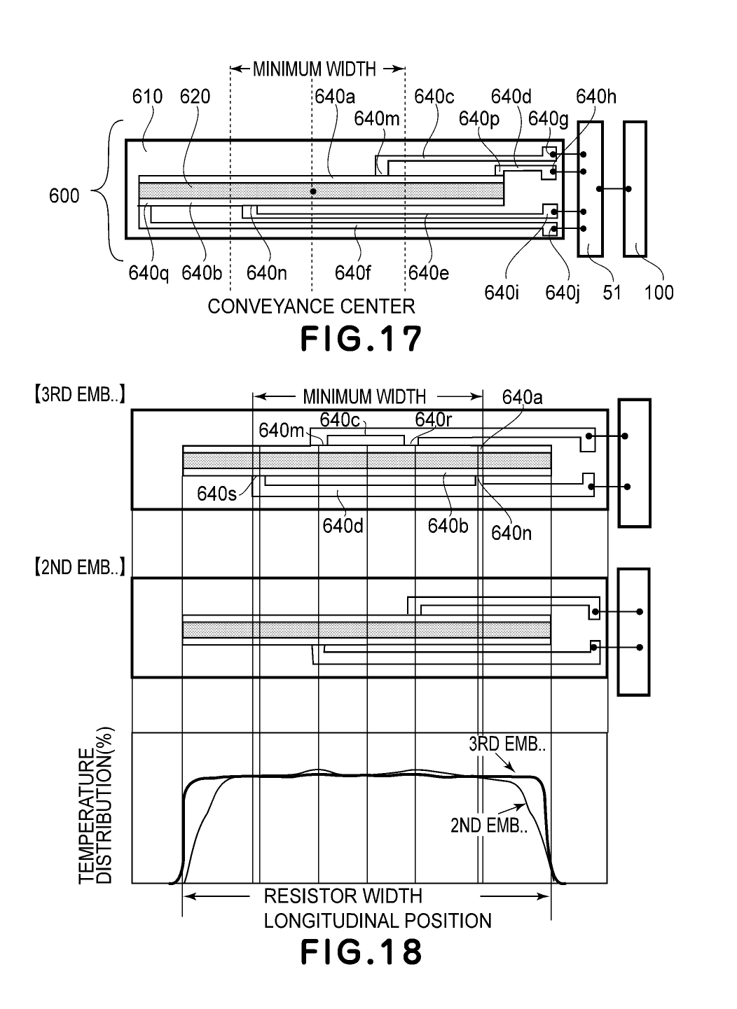

A heater shown in FIG. 17 has a constitution in which the connecting positions 640m and 640n in First Embodiment are replaced with those in Second Embodiment. The first electrode pair is the same as that in First Embodiment.

As for the second electric pair, with respect to the heat generating resistor 620, wiring patterns (electroconductive portions) 640a and 640b as the first electrode regions provided along the longitudinal direction in upstream and downstream sides, respectively, of the recording paper conveyance direction are disposed in common to the first and second electrode pairs. Further, connecting patterns 640c and 640e as the second electrode regions each connecting from the power source to the first electrode region are provided. The second electrode regions also include, in addition to the connecting patterns 640c and 640e, connecting patterns extending to connecting positions 640m and 640n where the connecting patterns are connected to the first electrode regions.

Further, by using the temperature control system described in First Embodiment, a uniform temperature distribution can be maintained over the entire longitudinal region. Further, in this embodiment, a relatively small-sized paper such as the post card as the minimum-sized paper can be set, and even in the case where a wide paper such as A3-sized paper is passed through the fixing device, alleviation of the temperature non-uniformity can be realized.

Incidentally, it has already been known that a good image is capable of being outputted by satisfying the fixing temperature of 200° C.±20° C. in the fixing device including the heater in Second Embodiment, so that in the case of the toner used in Second Embodiment, the good image was capable of being outputted in the entire longitudinal region under the above-described condition irrespective of the sheet size.

### Third Embodiment

In this embodiment, basic constitutions of the image forming portions and the fixing device are the same as those in the above-described embodiments, and constitutions of the wiring patterns and the connecting patterns which are connected to the heat generating resistor 620 are different from those in the above-described embodiments.

### (Heater)

FIG. 18 includes schematic views for illustrating a comparison of a heater constitution in this embodiment with the heater constitution in Second Embodiment. In this embodiment, to the wiring patterns 640a and 640b as the first electrode regions, the connecting patterns 640c and 640d as the second electrode regions are connected at connecting positions 640r and 640s, respectively, which are displaced in the longitudinal direction.

Further, to the wiring patterns 640a and 640b, the connecting patterns 640c and 640d are connected at the connecting positions 640m and 640n, respectively, so as to realize a common first electrode region and a common second electrode region.

The connecting positions 640m and 640r are connected to the wiring pattern 640a at substantially symmetrical positions with respect to the conveyance center line, and the connecting positions 640s and 640n are connected to the wiring pattern 640b at substantially symmetrical positions with respect to the conveyance center line. Further, the connecting positions 640m, 640n, 640r and 640s are set within the minimum sheet passing width. For example, in the case where the minimum sheet passing width is the width (size) of the post card, the connecting positions 640m, 640n, 640r and 640s are set within the post card width (size). Incidentally, their positions are set arbitrarily as long as the positions are deviated from each other with respect to the longitudinal direction within the minimum sheet passing width.

(Comparison of Temperature Distribution Between Electric Energy Supply in this Embodiment and in Second Embodiment

In FIG. 18, a result, measured by the thermography, of the temperature distribution immediately after the temperature is controlled for a long time (1 hour in this case) so that the detected temperature by a central main thermistor is kept at 200° C. by using each of the electric energy supply in this embodiment and in Second Embodiment is shown. As shown in FIG. 18, compared with Second Embodiment, in this embodiment, a plurality of pairs of the connecting positions are set, so that the current passing through the heat generating resistor 620 is more dispersed with respect to the longitudinal direction, and thus the temperature non-uniformity adjacent to the connecting positions was substantially eliminated.

Further, similarly as in Second Embodiment, the connecting positions are set within the minimum sheet passing width during the image forming operation, so that the recording paper passes through at least the connecting positions, and therefore the heat is absorbed and uniformized by the recording paper and thus the temperature non-uniformity within the recording paper width is further alleviated. However, when the connecting positions are set outside the minimum sheet passing width, in the case where the minimum-sized paper is passed through the fixing device, the connecting positions do not contact the recording paper to cause the temperature rise, and therefore such connecting positions cannot meet the minimum-sized paper.

From the above results, it is possible to reduce a degree of the longitudinal temperature non-uniformity by disposing the plurality of pairs of the connecting positions, of the wiring patterns with the connecting patterns, within the minimum sheet passing width while shifting the longitudinal coordinates of thereof.

(Modified Embodiment of this Embodiment)

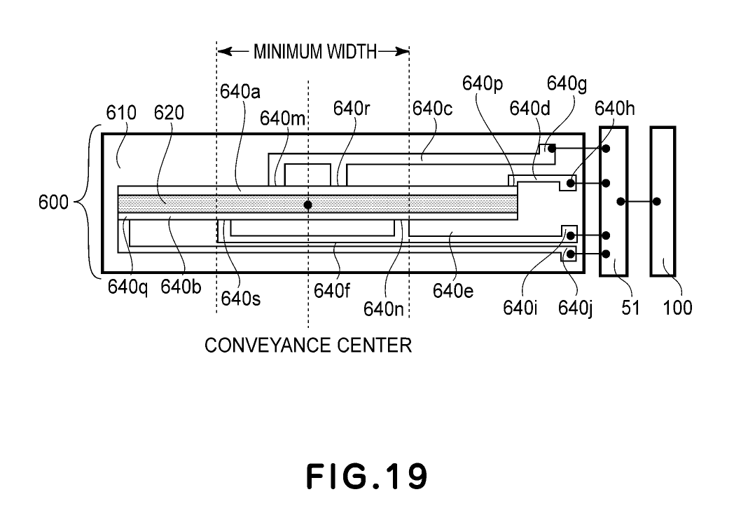

Further, as shown in FIG. 19, the central portion electric energy supply in First Embodiment can be replaced with the above-described central portion electric energy supply in Third Embodiment in which the plurality of pairs of the connecting positions are set within the minimum sheet passing width, so that the degree of the temperature non-uniformity can be further reduced. That is, in the constitution in FIG. 19, the connecting positions 640m and 640n in First Embodiment are replaced with the plurality of pairs of the connecting positions in Third Embodiment, and the plurality of pairs of the connecting positions are set so that their longitudinal coordinates are deviated from each other as in Third Embodiment. Further, by using the temperature control described in First Embodiment, the longitudinal temperature non-uniformity adjacent to the connecting positions is alleviated.

Thus, when the plurality of central electrode pairs, i.e., two or more central electrode pairs provided at least adjacent to the central portion with respect to the recording paper conveyance direction are located within the minimum sheet passing width, it becomes possible to prevent the occurrence of the temperature non-uniformity on the recording paper. Incidentally, it has already been known that a good image is capable of being outputted by satisfying the fixing temperature of 200° C.±20° C. in the fixing device in the constitution in Third Embodiment, so that in the case of the toner used in Third Embodiment, the good image was capable of being outputted in the entire longitudinal region under the above-described condition irrespective of the sheet size.

### (Other Modified Embodiments of Third Embodiment)

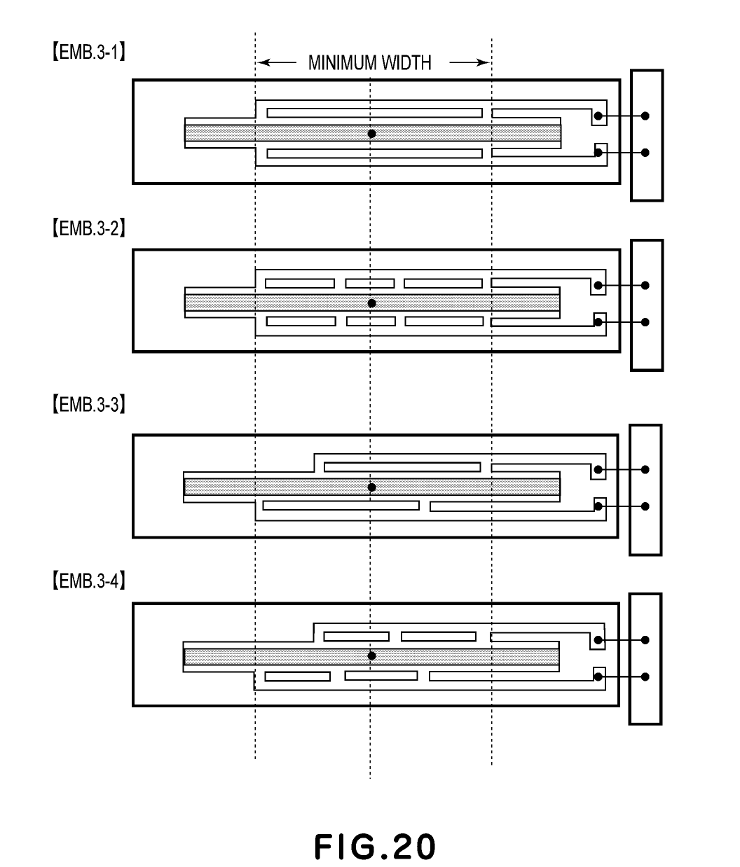

Further, as shown in FIG. 20, four embodiments (Embodiments 3-1 to 3-4) each in which a plurality of pairs of connecting positions are set within the minimum-sized sheet passing width as described in Third Embodiment can be employed in the present invention. In either of the embodiments, the above-described effects in Third Embodiment can be achieved.

### Fourth Embodiment

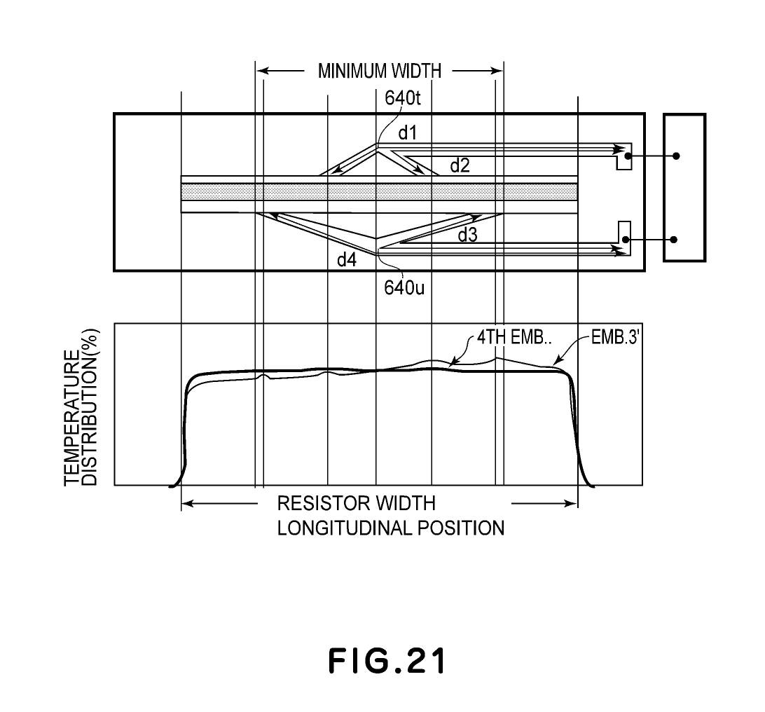

In this embodiment shown in FIG. 21, basic constitutions of the image forming portions and the fixing device are the same as those in the above-described embodiments, and constitutions of the wiring patterns and the connecting patterns which are connected to the heat generating resistor 620 are different from those in the above-described embodiments. In this embodiment, to the heat generating resistor 620, two wiring patterns are connected in parallel along the longitudinal direction, and each of the wiring patterns is connected to a plurality of connecting patterns. However, as described above, the connecting patterns connected to the control circuit portion have high electrocondutivity but their resistance values are not zero.

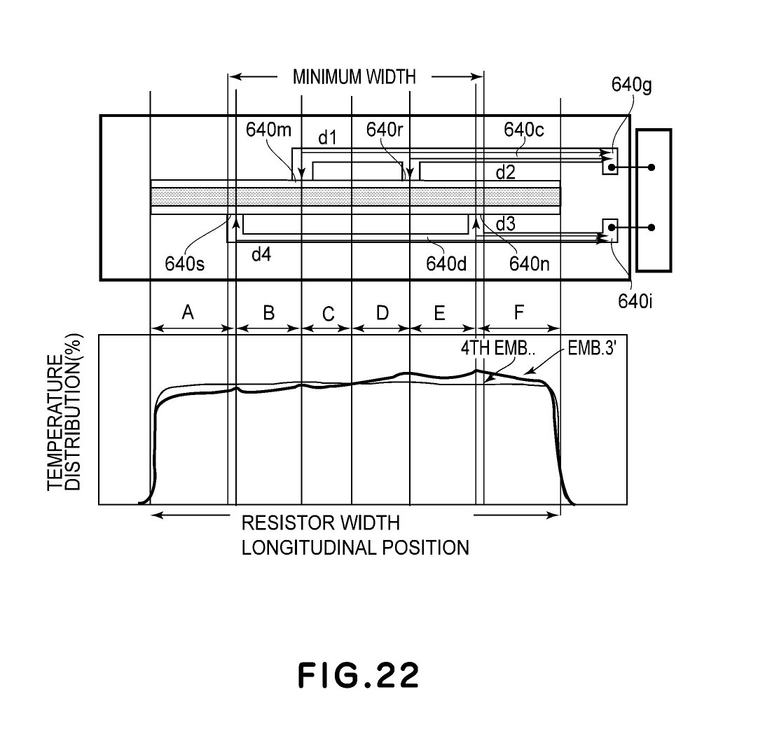

For example, a constitution in FIG. 22 will be described. When distances from electrodes 640g and 640i to connecting positions 640m, 640n, 640r and 640s are connecting position-electrode distances d1, d2, d3 and d4 as indicated in FIG. 22, these connecting position-electrode distances satisfy relationships of: d1>d2 and d3>d4. In the constitution in FIG. 22, each of the wiring patterns and the connecting patterns is formed f a material having a volume resistivity of 10 mΩ/sq and is formed of 10 μm in thickness and about 1.0 mm in width. In the constitution in FIG. 22, with respect to the longitudinal temperature non-uniformity, a desired effect can be obtained, but in the case where the connecting patterns are connected to the wiring patterns at the plurality of longitudinal positions, the width of the heater is required to be increased as a whole.

Therefore, an embodiment in the case where the heater is intended to be downsized by using the same material for the wiring patterns and the connecting patterns will be described as Embodiment 3′. In Embodiment 3′, the thickness and width of each of the wiring patterns and the connecting patterns were decreased to ½ (thickness of 5 μm and width of 0.5 mm) of those in Fourth Embodiment. In this case, a result of a comparison of the temperature distribution in Embodiment 3′ with the temperature distribution in Fourth Embodiment is shown in FIG. 22. In FIG. 22, an upper part showing the heater constitution is common to Embodiment 3′ and Fourth Embodiment since only the thickness and width of each pattern are changed. From the result shown in FIG. 22, a temperature difference among regions adjacent to the connecting positions became conspicuous in Embodiment 3′.

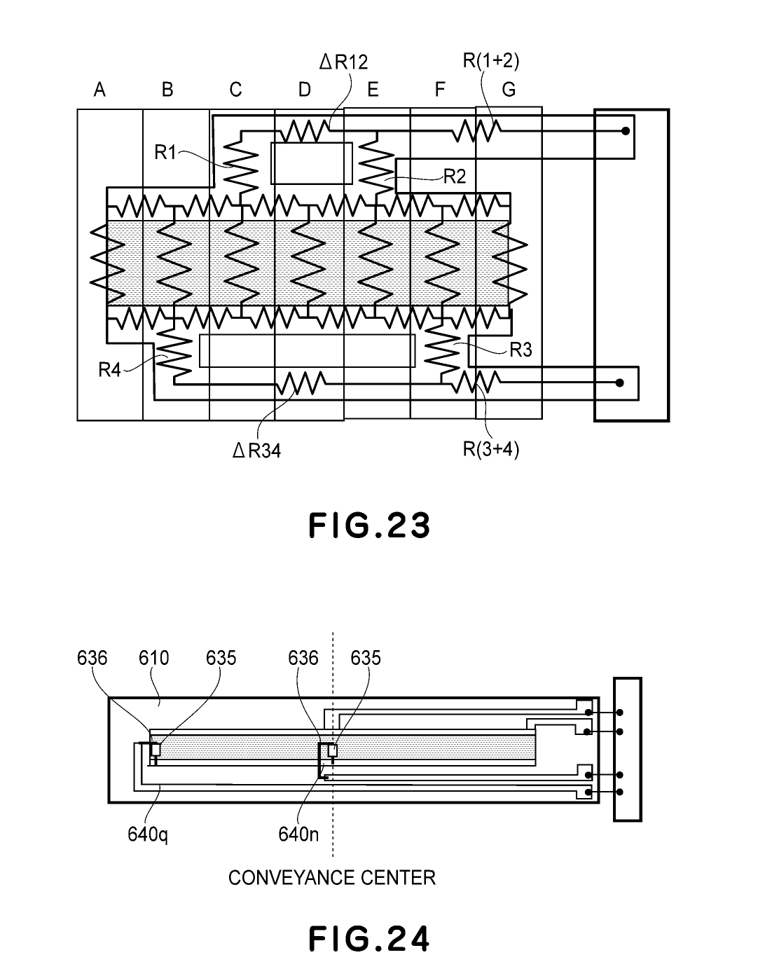

This result will be described with reference to FIG. 23. FIG. 23 is a circuit diagram of the heater 600 in Embodiment 3′. In FIG. 23, resistors of the heat generating resistor and the wiring and connecting patterns when the heater 600 is divided into 7 areas are schematically illustrated. Resistance values of the respective resistors R1, R2, R3, R4, R(1+2), R(3+4), ΔR12 and ΔR34 are increased by the reduction in thickness and width, and combined resistance values in connecting position-electrodes distances are increased in proportional to lengths (distances) d1, d2, d3 and d4.

Accordingly, by voltage drop from the electrode to the connecting position to the heat generating resistor 620, a current passing through the heat generating resistor 620 is lowered with an increasing connecting position-electrode distance, so that the longitudinal temperature non-uniformity of the heater appears conspicuously. Further, as the connecting pattern becomes thinner and narrower, a variation in sensitivity to the distance becomes large.

Therefore, in the constitution in Fourth Embodiment, as shown in FIG. 21, the combined resistance values from the connecting positions to the electrodes are made equal, so that non-uniformity of the amount of the current passing through the heat generating resistor is prevented from occurring. Specifically, such a constitution can be realized by setting the connecting position-electrode distances so as to satisfy: d1=d2 and d3=d4. For example, in a path from the electrode 640g toward the connecting positions 640m and 640r, a common path is formed from the electrode 640g to a branch point 640t, and distances of a path from the branch point 640t to the connecting position 640m and a path from the branch point 640t to the connecting position 640r is made equal in length (distance) (i.e., d1=d2). Further, the electrode 640i is provided in a side opposite to the electrode 640g side with respect to the widthwise direction, in a path from the electrode 640i toward the connecting positions 640s and 640n, a common path is formed from the electrode 640i to a branch point 640u, and distances of a path from the branch point 640u to the connecting position 640n and a path from the branch point 640u to the connecting position 640s is made equal in length (distance) (i.e., d3=d4).

As a result, the parts except the pressings ΔR12 and ΔR34 which change the combined resistance values described in FIG. 23, i.e., the paths of the patterns from the electric energy supply electrodes 640g and 640i to the heat generating resistor 620 are made equal to each other in length. As a result, combined resistance values Rd1 and Rd2 from the electrode 640g in the paths d1 and d2 are equal to each other, and combined resistance values Rd3 and Rd4 from the electrode 640i in the paths d3 and d4 are equal to each other, so that the longitudinal temperature non-uniformity of the heat generating resistor is alleviated.

In this embodiment, the connecting position-electrode distances in the same pattern are made equal to each other, so that current non-uniformity due to voltage drop of the wiring and connecting patterns was prevented. Separately from this, the connecting patterns may only be required that the combined resistance values from the connecting positions to the electrodes are equal to each other, and this may also be adjusted by a material, a shape (e.g., cross-sectional area), or the like.

Incidentally, with respect to the toner used in First Embodiment, it has already been known that a good image is capable of being outputted by satisfying the fixing temperature of 200° C.±20° C. in the fixing device in the constitution in First Embodiment, so that in the constitution in First Embodiment, the good image was capable of being outputted in the entire longitudinal region under the above-described condition irrespective of the sheet size.

### Fifth Embodiment

FIG. 24 shows a heater constitution in this embodiment in which a countermeasure element (electric energy supply shut-off element) during abnormal generation is provided. In FIG. 24, adjacent to electrodes where the current flows into the heat generating resistor thermal fuses 635 as the countermeasure element during the abnormal heat generation are disposed. As the thermal fuses 635, those of various types can be used, but those of a temperature-sensitive pellet type having high responsivity are generally used in the image heating apparatus. Each thermal fuse 635 is connected in series with an electric circuit including the electrode 640, an electric power supply source and the heat generating resistor. During the abnormal heat generation in the fixing operation, by short-circuiting the thermal fuse 635, the circuit from the electric power supply source to the heat generating resistor is shut off, so that heat generation is suppressed.

Further, in this embodiment, the two thermal fuses 635 are disposed, depending on an electric energy supply state of the heat generating resistor, at two positions (a longitudinal central position and a longitudinal left end position in a downstream side with respect to the recording paper conveyance direction crossing the longitudinal direction, so that this arrangement is capable of meeting each of the electric energy supply states and thus is effective. The arrangement of the thermal fuses 635 is not limited to that shown in FIG. 24 but may only be required that the thermal fuse 635 is disposed at at least one position of the connecting positions in upstream and downstream sides.

Incidentally, each thermal fuse 635 is connected with the electrode 640 via a connecting wire 636 by welding. In this embodiment, the thermal fuses 635 are disposed adjacent to the electric energy supply portions, and therefore even in such a situation that the heater is placed in an abnormal state and thus the electric energy supply to the heater is delayed, it becomes possible to quickly short-circuit the electric circuit since the thermal fuses are disposed adjacent to the electrodes where the temperature becomes highest.

Similarly, in the case where the thermal fuses are provided at longitudinal end portions, these thermal fuses are intended to be effectively actuated in a state in which the electric energy is supplied from the electrodes at the longitudinal end portions. In this case, the temperature at the longitudinal end portions becomes high, and therefore by disposing the thermal fuses 635 adjacent to the electrodes at the longitudinal end portions, it is possible to quickly realize the short circuit and thus reliability can be further improved. Incidentally, in this embodiment, as the electric energy supply shut-off element, the thermal fuse is used, but a thermo-switch using bimetal may also be used.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 127964/2012 filed Jun. 5, 2012, which is hereby incorporated by reference.

What is claimed is:

1. An image heating apparatus comprising:
(i) an endless belt for heating a toner image on a sheet at a nip;
(ii) a rotatable driving member for forming the nip in cooperation with said endless belt and for rotating said endless belt;
(iii) a heater, provided opposed to said rotatable driving member via said endless belt, for heating said endless belt, wherein said heater comprising:
(iii-i) a substrate;
(iii-ii) a resistor, provided on said substrate along a longitudinal direction of said substrate, for generating heat by electric energy supply;
(iii-iii) a first electroconductive portion provided on said substrate along the longitudinal direction and electrically connected to said resistor in a widthwise end side; and
(iii-iv) a second electroconductive portion provided on said substrate along the longitudinal direction and electrically connected to said resistor in another widthwise end side; and
(iv) a selector for selecting one of a plurality of electric energy supply paths including a first electric energy supply path for supplying electric energy to said resistor and a second electric energy supply path for supplying the electric energy to said resistor,
wherein said first electric energy supply path is electrically connected to a region of said first electroconductive portion adjacent to a longitudinal central portion of said resistor and to a region of said second electroconductive portion adjacent to the longitudinal central portion of said resistor, and
wherein said second electric energy supply path is electrically connected to a region of said first electroconductive portion adjacent to a longitudinal end portion of said resistor and to a region of said second electroconductive portion adjacent to another longitudinal end portion of said resistor.

2. An apparatus according to claim 1, wherein said selector selects one of the plurality of electric energy supply paths depending on a widthwise size of the sheet.

3. An apparatus according to claim 2, wherein said selector selects a first mode when the sheet having the widthwise size narrower than a maximum widthwise size of the sheet usable in said image heating apparatus is subjected to an image heating process, and selects a second mode when the sheet having the maximum widthwise size is subjected to the image heating process.

4. An apparatus according to claim 1, further comprising:
an electric energy supply shut-off element for shutting off the electric energy supply with temperature rise of said heater to an abnormal temperature, wherein said electric energy supply shut-off element is located in the first electric energy supplying path and in the region of said first electroconductive portion adjacent to the longitudinal central portion of said resistor; and
another electric energy supply shut-off element for shutting off the electric energy supply with temperature rise of said heater to an abnormal temperature, wherein said another electric energy supply shut-off element is located in the second electric energy supplying path and in the region of said first electroconductive portion adjacent to the longitudinal end portion of said resistor.

5. An image heating apparatus comprising:
(i) an endless belt for heating a toner image on a sheet at a nip;
(ii) a rotatable driving member for forming the nip in cooperation with said endless belt and for rotating said endless belt;
(iii) a heater, provided opposed to said rotatable driving member via said endless belt, for heating said endless belt, wherein said heater comprising:
(iii-i) a substrate;
(iii-ii) a resistor, provided on said substrate along a longitudinal direction of said substrate, for generating heat by electric energy supply;
(iii-iii) a first electroconductive portion provided on said substrate along the longitudinal direction and electrically connected to said resistor in a widthwise end side;
(iii-iv) a first central electric energy supply path connected to a region of said first electroconductive portion adjacent to a longitudinal central portion of said resistor;
(iii-v) a first end electric energy supply path connected to a region of said first electroconductive portion adjacent to a longitudinal end portion of said resistor;
(iii-vi) a second electroconductive portion provided on said substrate along the longitudinal direction and electrically connected to said resistor in another widthwise end side;
(iii-vii) a second central electric energy supply path connected to a region of said second electroconductive portion adjacent to a longitudinal central portion of said resistor;
(iii-viii) a second end electric energy supply path connected to a region of said second electroconductive portion adjacent to another longitudinal end portion of said resistor; and
(iv) a selector for selecting one of a plurality of modes including a first mode in which the electric energy is supplied to said resistor by using said first central electric energy supply path and said second central electric energy supply path and including a second mode in which the electric energy is supplied to said resistor by using said first end electric energy supply path and said second end electric energy supply path.

6. An apparatus according to claim 5, wherein said selector selects one of the plurality of electric energy supply paths depending on a widthwise size of the sheet.

7. An apparatus according to claim 6, wherein said selector selects a first mode when the sheet having the widthwise size narrower than a maximum widthwise size of the sheet usable in said image heating apparatus is subjected to an image heating process, and selects a second mode when the sheet having the maximum widthwise size is subjected to the image heating process.

8. An apparatus according to claim 5, further comprising:
an electric energy supply shut-off element for shutting off the electric energy supply with temperature rise of said heater to an abnormal temperature, wherein said electric energy supply shut-off element is located in the first electric energy supplying path and in the region of said first electroconductive portion adjacent to the longitudinal central portion of said resistor; and
another electric energy supply shut-off element for shutting off the electric energy supply with temperature rise of said heater to an abnormal temperature, wherein said another electric energy supply shut-off element is located in the second electric energy supplying path and in the region of said first electroconductive portion adjacent to the longitudinal end portion of said resistor.

9. An image heating apparatus comprising:
(i) an endless belt for heating a toner image on a sheet at a nip;
(ii) a rotatable driving member for forming the nip in cooperation with said endless belt and for rotating said endless belt;
(iii) a heater, provided opposed to said rotatable driving member via said endless belt, for heating said endless belt, wherein said heater comprising:
(iii-i) a substrate;
(iii-ii) a resistor, provided on said substrate along a longitudinal direction of said substrate, for generating heat by electric energy supply;
(iii-iii) a first electroconductive portion provided on said substrate along the longitudinal direction and electrically connected to said resistor in a widthwise end side;
(iii-iv) a second electroconductive portion provided on said substrate along the longitudinal direction and electrically connected to said resistor in another widthwise end side; and
(iv) an electric energy supplying device for supplying electric energy to said resistor, wherein said electric energy supplying device is connected at a plurality of positions to each of said first electroconductive portion and said second electroconductive portion.

10. An apparatus according to claim 9, wherein said electric energy supplying device is connected to said first electroconductive portion at the positions substantially equidistant from a longitudinal central portion of said resistor, and is connected to said second electroconductive portion at the positions substantially equidistant from the longitudinal central portion of said resistor.
